(19) United States
(12) Patent Application Publication
(10) Pub. No.: US 2013/0030923 A1
(43) Pub. Date: Jan. 31, 2013

(54) Method and System for Document Generation from Projected Financial Aid Award

(71) Applicants: Craig V. Carroll, Double Bay (AU); David M. Childress, Sacramento, CA (US); John F. Deleppo, Franklin, MA (US); Christina E. Kline, Brockton, MA (US); Christiane Thy Nguyen, West Sacramento, CA (US); Robert T. Reeder, Southborough, MA (US)

(72) Inventors: Craig V. Carroll, Double Bay (AU); David M. Childress, Sacramento, CA (US); John F. Deleppo, Franklin, MA (US); Christina E. Kline, Brockton, MA (US); Christiane Thy Nguyen, West Sacramento, CA (US); Robert T. Reeder, Southborough, MA (US)

(73) Assignee: REZOLVE GROUP, INC., Sacramento, CA (US)

(21) Appl. No.: 13/193,040

(22) Filed: Jul. 28, 2011

(51) Int. Cl. G06Q 30/02; G06Q 50/20

(52) U.S. Cl. 705/14.66

(57) ABSTRACT

A computer system and method that enables the customization and personalization of marketing material for potential students utilizing existing systems to provide students with net price information on the cost of attending an academic institution and supplements the financial information with marketing information that is customized and created for the potential student. The marketing material is unique to each potential student and is generated for each student based on their financial circumstances, personal interests and academic goals.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Many academic institutions provide admission, enrollment, and cost information to prospective students via their websites or by way of standardized prospectuses or brochures that profile and overview information about the academic institution. This is especially true for post-secondary institutions. The academic institutions will also often provide more detailed cost information, such as the published tuition costs, room and board costs, and miscellaneous costs, such as books and laboratory fees, which typical students might be required to pay as a consequence of their attendance at the academic institution. Likewise, institutions will often provide general (non-student specific) information about how to apply for financial aid programs such as scholarships, loans, work-study programs, and grants that students might access while attending the academic institution.

While having this information is helpful for potential students, it does not provide a complete explanation or break-down of the prospective student's out-of-pocket or net price of attendance because each student's academic achievements, educational desires and financial circumstances are different. Academic institutions price each student differently based on academic achievements, educational desires and financial circumstances hence ‘standardized’ or general information on the cost of a degree is not actually relevant for any single individual, prospective student Students struggle to understand their eligibility for student aid programs because there is a wide variety of criteria used to determine awarding, which is based on each student's unique circumstances, e.g. personal and family income, personal and family assets, academic abilities, desired program or degree of study, state of residency, marital status, family parental situation and enrollment status, to name a few. Based on these criteria, there are a multitude of outcomes in terms of costs and eligibility for student financial aid—some students may need to finance all of their educational costs, others may only need to finance a portion or none of their education, some students will quality for substantial grants, and some will qualify for none.

To address this need, many institutions provide net price calculators to prospective students. These software systems provide prospective students with personalized net price estimates. They often take into account the students' unique characteristics, the institution's unique financial aid offerings as well as the student's eligibility for federal, state and/or military student aid.

### SUMMARY OF THE INVENTION

Academic institutions compete for the best students. While enrolling enough students for each academic class is certainly important for the financial survival of the institutions, most institutions are more concerned with seeking out the best potential students in terms of academic performance and success after graduation. These metrics are critical to each institution if it wants to improve its ranking relative to other institutions or build an alumni network.

At the same time, students can be unsophisticated, on one hand. For most potential students, this is first and possibly last time that they will be enrolling at a post-secondary academic institution. Further, the number of options for each student is typically large and varied. The number of colleges in the United States is measured in the many thousands.

On the other hand, simply selecting a university can be a very complex process. Student interests are diverse. A given student may choose between different institutions based on available degree programs, extracurricular programs, sports programs, quality of campus life, geographic locations, to list a few factors. A prospective student may not be able to readily assess the academic, social and financial fit between his/her aspirations and the unique characteristics and offerings of different academic institutions.

The present invention concerns a computer system and method that enables the mass customization and personalization of marketing material for potential students. It leverages existing systems that provide students with net price information on the cost of an academic institution and supplements this financial information with marketing information that is customized and created for the potential students based on the financial information they provided along with any other information that the potential students provide such as desired degree type (e.g. associates or bachelors degree), program of study and/or major (nursing, engineering, English literature), extracurricular activities (clubs, student government), student life issues (on and off campus housing, dining options), and sports programs and teams (football, soccer).

The present invention is able to dynamically compile, display and/or print individually-relevant information so that the each unique, prospective student can quickly ascertain the ability of the institution to meet their own specific academic, social and financial goals. As a result, content is able to be delivered to prospective students that is individually relevant and appropriate for each specific student's interests, aspirations and/or desires. Moreover this content is integrated with the critical information concerning available financial aid and expected aid awards. All of this information is customized for each potential student.

In some cases, the marketing material is sent to all students that access the institutions' net price calculator systems. In other cases, the institutions analyze the prospective students based certain criteria and then only generate and provide the marketing information to students that have the criteria that the institutions desire or are seeking.

In general, according to one aspect, the invention features a computerized method for generating a personalized document for marketing an academic institution to a potential student. The method comprises generating a user interface that enables entry of candidate personal information including candidate financial information into a computer system for the potential student, the computer system determining expected financial aid award information for the potential student from the candidate financial information, the computer system determining personalized marketing content that is relevant to the potential student based on the candidate personal information, and the computer system generating a document customized to the potential student that includes the expected financial award information and personalized marketing content.

In general, according to another aspect, the invention features a computer system that performs the foregoing method.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating an overview of the relationship between potential students, the academic institution's website, the computer system for calculating net price of attendance, and the printing and mailing system that generates the award packages.

FIG. 2A is a block diagram illustrating the relationship between business rules and transactional databases, net price calculator user interface screens, the method steps in the generation of award packets, and document generation components.

FIG. 2B is a block diagram that shows how data are stored as data files within the business rules database and transactional database.

FIG. 3A shows an exemplary welcome screen displayed to candidates and provides introductory information about the net price calculator and survey that is generated as part of a user interface by the computer system.

FIG. 3B shows an exemplary registration screen that candidates must complete before beginning the survey that is generated as part of a user interface by the computer system.

FIG. 3C shows an exemplary personal interest survey questions screen.

FIG. 4 shows an exemplary personal information screen that requires the potential student to enter family information about dependency and military service that is generated as part of a user interface by the computer system.

FIG. 5 shows an exemplary a personal information screen that requires the potential student to enter additional personal information related to the potential student's citizenship, residency, and their high school that is generated as part of a user interface by the computer system.

FIG. 6 shows an exemplary academic information screen that requires the potential student to enter information about academics that is generated as part of a user interface by the computer system.

FIG. 7 shows an exemplary academic information screen that requires the potential student to enter information about their academic performance to aid in calculating merit-based financial aid that is generated as part of a user interface by the computer system.

FIG. 8 shows an exemplary financial information screen that requires the potential student to enter financial information that is generated as part of a user interface by the computer system.

FIG. 9A shows an exemplary net price calculator results screen provides an overview of estimated cost of attendance for specified academic institutions that is generated as part of a user interface by the computer system.

FIG. 9B shows an exemplary financing your education screen that provides information on estimated cost of attending the academic institution and estimated monthly payments upon graduation that is generated as part of a user interface by the computer system.

FIG. 9C shows an exemplary financing your education screen for an institutional payment plan based on the entire duration of a program or degree.

FIG. 10 shows an exemplary report summary.

FIG. 11 shows an exemplary cover page of an award packet PDF 1138 and how the data are transferred to the award packet to create a personalized award document for each potential student.

FIG. 12 shows an exemplary custom welcome letter award packet PDF 1138 and how the data are transferred to the award packet to create a personalized award document for each potential student.

FIG. 13 shows an exemplary total price summary page and how the data are transferred to the award packet to create a personalized award document for each potential student.

FIG. 14 shows an exemplary back cover page and how the data are transferred to the award packet to create a personalized award document for each potential student.

FIG. 15 shows an exemplary education pays page from an award packet.

### DETAILED DESCRIPTION OF THE PREFERRED EMBODIMENTS

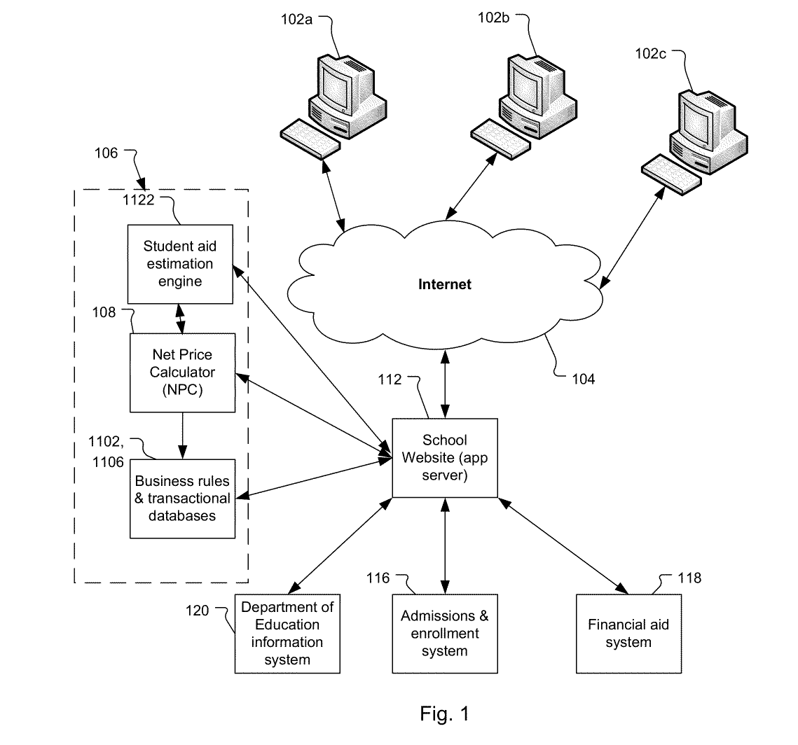

FIG. 1 illustrates an overview of the relationship between potential students 102a-c, the academic institution's website 112, the computer system 106 for calculating net price of attending an academic institution, and the integration with institutional computer/student aid information systems such as an admissions computer system 116 and a financial aid and/or bursar's computer system 118.

In a typical implementation, potential students or candidates 102a-c use personal computers, laptops, tablet devices, or smart phones to access an academic institution's website 112 via a computer network such as the Internet 104. In a preferred embodiment, the potential students 102a-c use internet browsers to navigate to a website either hosted by the academic institution or by a third party. In an alternative embodiment, the potential students may access the school's website from a computer terminal or kiosk located on the institution's campus.

A graphical user interface is presented to the potential students 102a-c by the computer system 106 preferably as series of served web pages. The graphical user interface guides the potential students through a series of screens that display information, directions, and questions that are part of a survey that needs to be completed by the potential student to determine a net price calculation. The data from the survey enable a student aid estimation engine 1122 of the computer system 106 to determine a student's eligibility for various types of aid programs as a well as predicted amount financial aid.

The net price calculator 108 is a software program executed by the computer system 106 that calculates the cost and net price of attendance to a specified academic institution. Additionally, the information entered by the potential students is transferred to the business rules and transactional databases 1102, 1106. The stored information is then able to be accessed later by the computer system 106 when generating a net price calculation or when generating a customized award packet for each potential student. Similarly, potential students are able to access, edit, review, and delete the information as well. Additionally, if the potential student decides to apply or enroll at the academic institution the collected data are used to expedite the application process after transfer to the admissions and enrollment system 116 because the potential student would not need to re-enter all of their information again.

Generally, the business rules database stores all of the custom photos, custom paragraphs, school logos, templates, admission metrics, and general policies and/or rules the academic institution uses for creating award packets. The transactional database stores the potential student's information obtained by the computer system 106 during the NPC survey as well as the results generated by the net price calculator 108 and the student aid estimation engine 1122.

In an alternative embodiment, if the candidate previously applied to or currently attends the academic institution, then the candidate's personal information, academic information, and financial information is parsed from the other computer systems, e.g. 120, 118, 116, and loaded to the computer system 106. Similarly, the information obtained during the survey is able to be transferred to the Department of Education information system 120 typically as part of a Free Application for Federal Student Aid (FAFSA), admissions and enrollment system 116, or financial aid system 118.

If the academic institution determines that a student is going to receive an award packet, the information is sent to a print shop (or letter shop). Typically, the letter shop is a third party business that specializes in printing and mailing large quantities of documents. The letter shop handles the printing, addressing, adding postage, stuffing (or inserting the document into an envelope), sealing, and preparing the mail to be sent through the postal system. In an alternative embodiment, the letter shop is part of the academic institution and all of the printing, stuffing, and mailing are performed by the academic institution. The custom award packet is then mailed to the potential student.

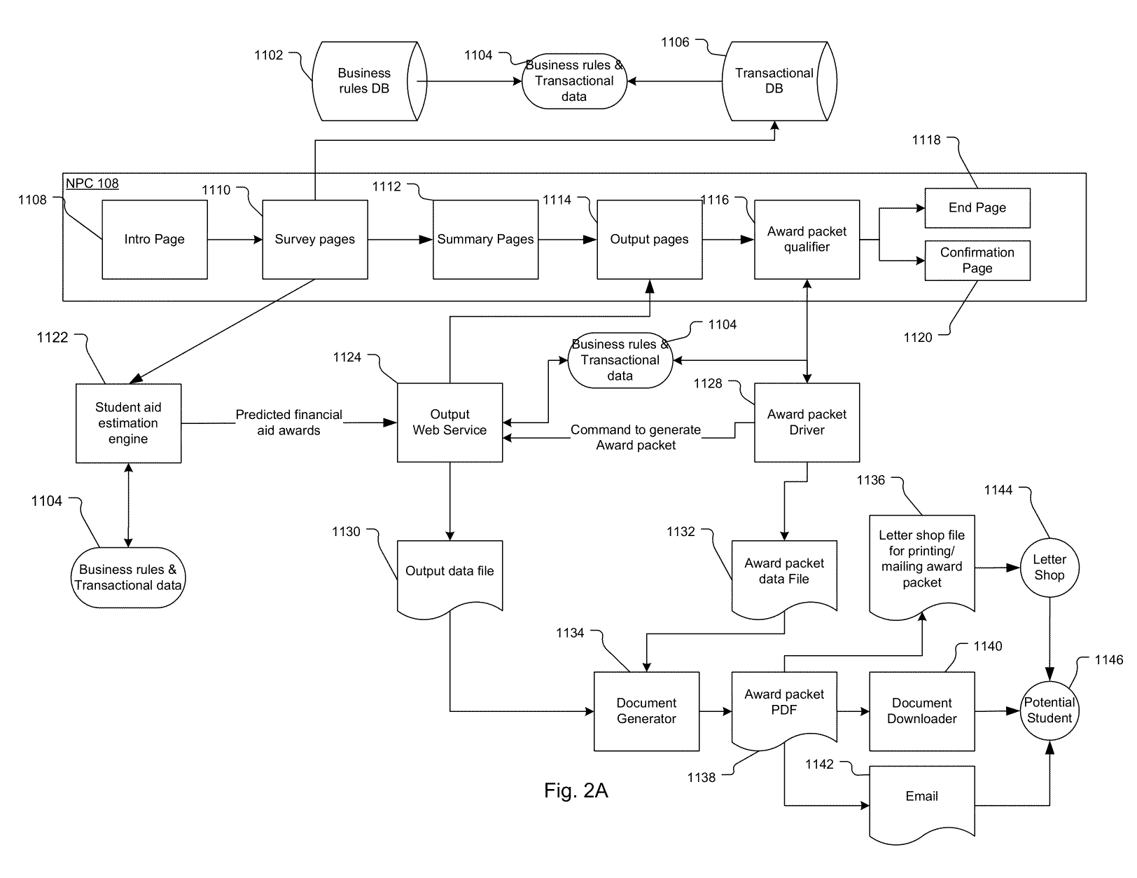

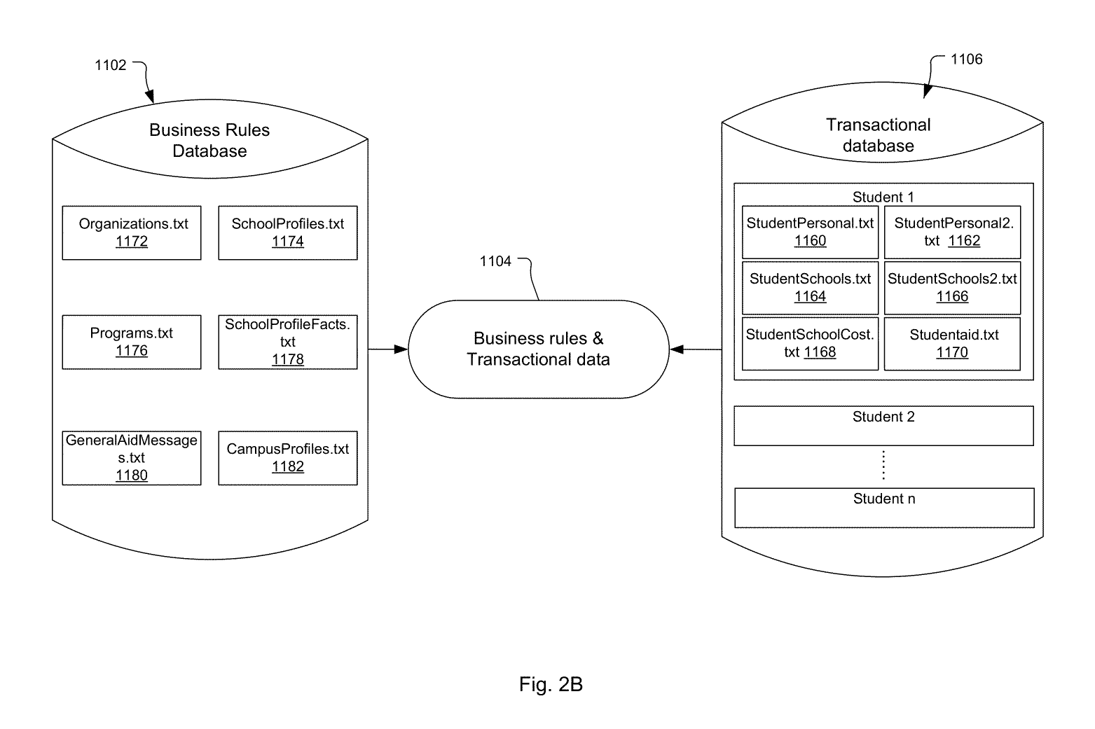

FIG. 2A is a block diagram illustrating the relationship between the databases 1102, 1106, net price calculator 108, and award packet 1138.

The business rules database 1102 stores the custom information that is included with the individual award packet such as custom paragraphs, custom photos/images, custom backgrounds, institution information, the school contact information, and template information, to list a few examples. The stored content enables the computer system 106 to generate individualized award packets for each potential student that is tailored to each potential student's academic goals and personal interests that are collected during the survey 1110. For example, if a potential student is interested in engineering, then the award packet includes custom photos, paragraphs, backgrounds, and templates related to science and engineering. Additionally, the award packet also includes additional, detailed information that may be of interest to the potential student such as prominent engineering professors, information about the engineering department and curriculum, or science/engineering clubs on campus.

The business rules and transactional data 1104 encompass all the business rules data and transactional data stored in the business rules database 1102 and transactional database 1106.

In a typical implementation, a potential student or candidate uses a computer 102 to navigate to a website hosted by an academic institution or by a third party to access the price calculator (NPC) 108. The net price calculator 108 is displayed as a graphical user interface presented to the potential students by the computer system. The graphical user interface guides the potential students through a series of screens that display general information, directions, and questions that are part of a survey that needs to be completed by the potential student. Additionally, the user interface allows users navigate forward and backward through the survey to edit and review the entered information.

Because the entered information is stored in the transactional database 1106, the computer system 106 enables returning users to access their account and to complete a partially completed survey or view a previously completed survey. If, however, the potential student is a new user then the computer system 106 requires the candidate to register and create an account if they want to receive an award packet.

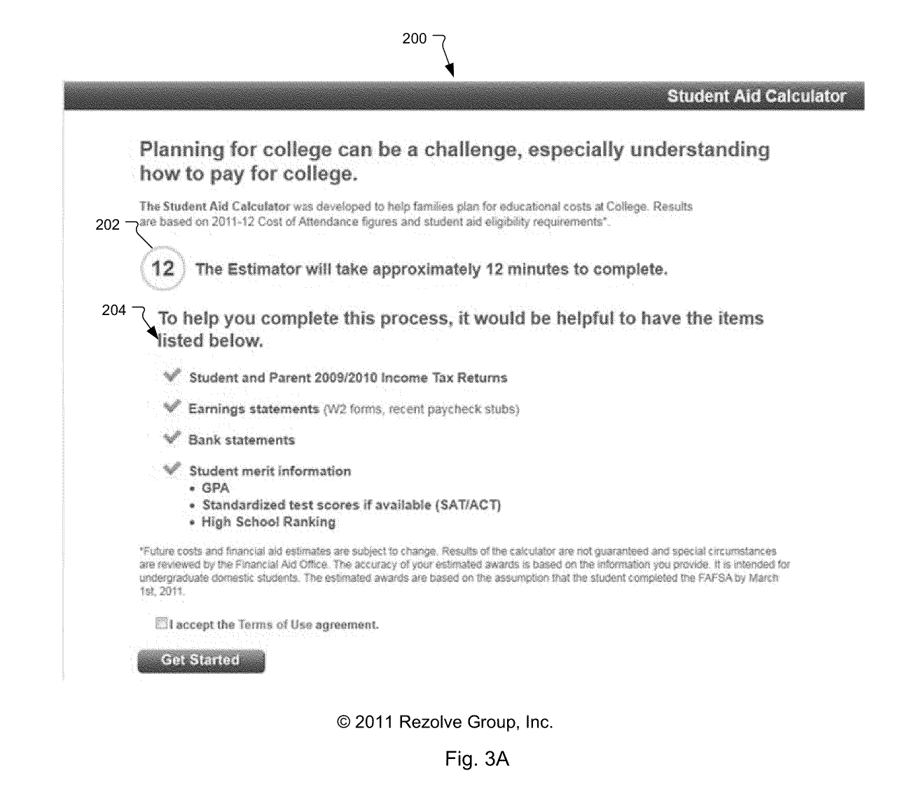

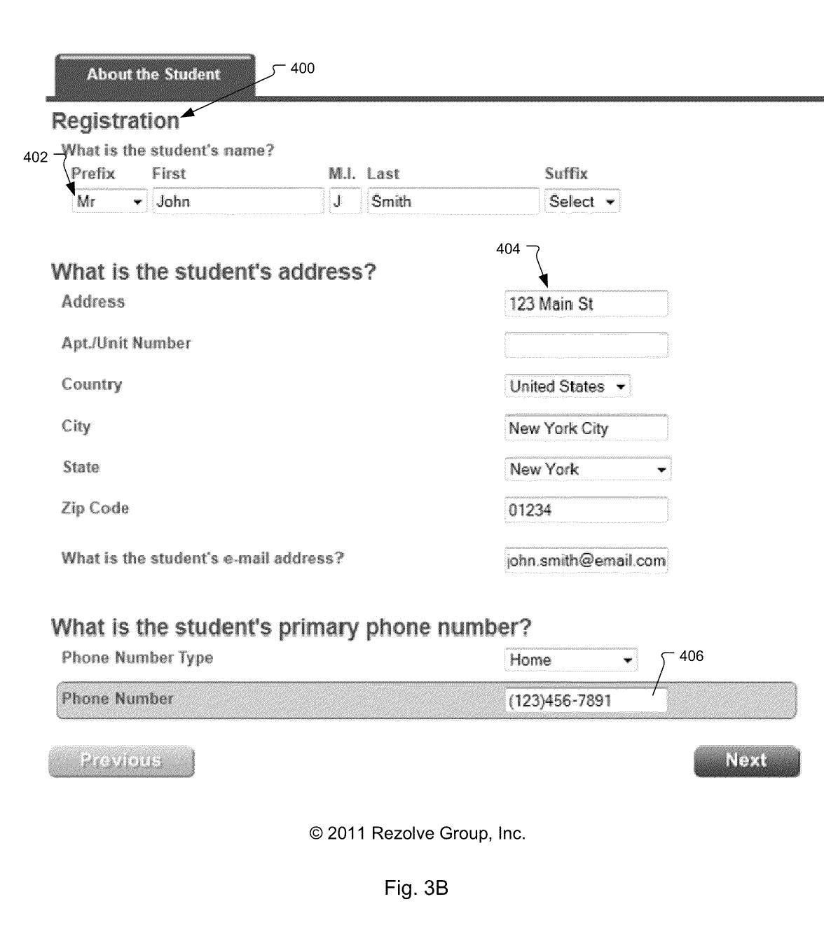

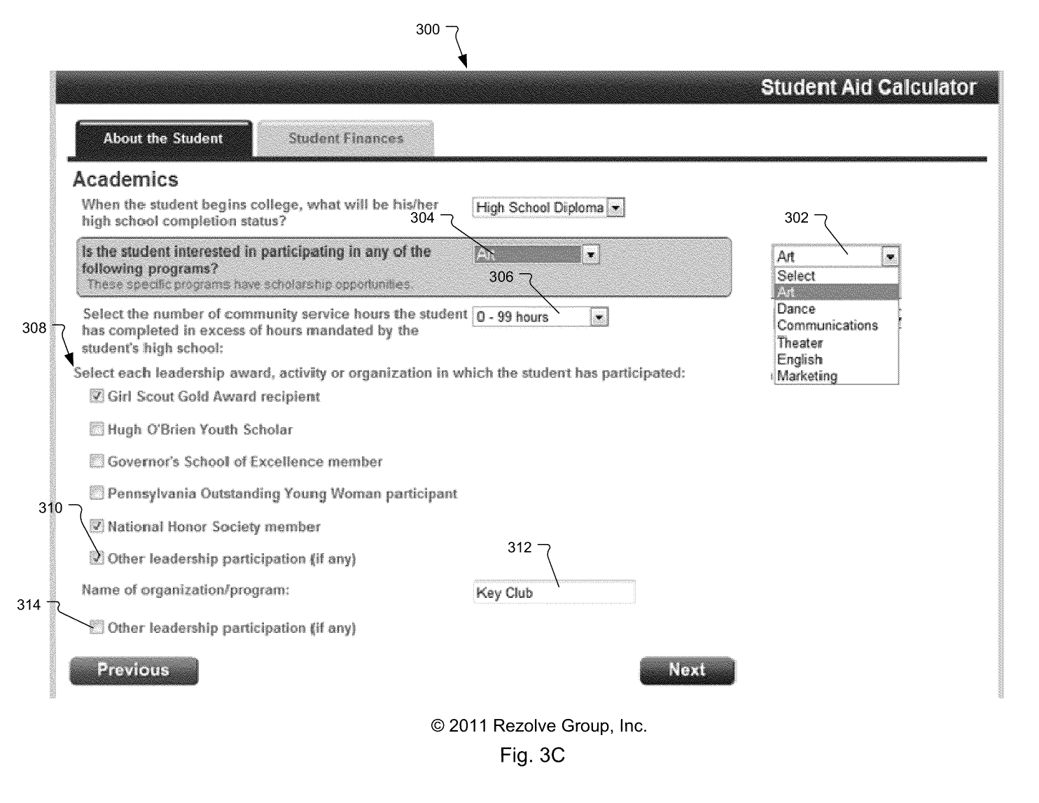

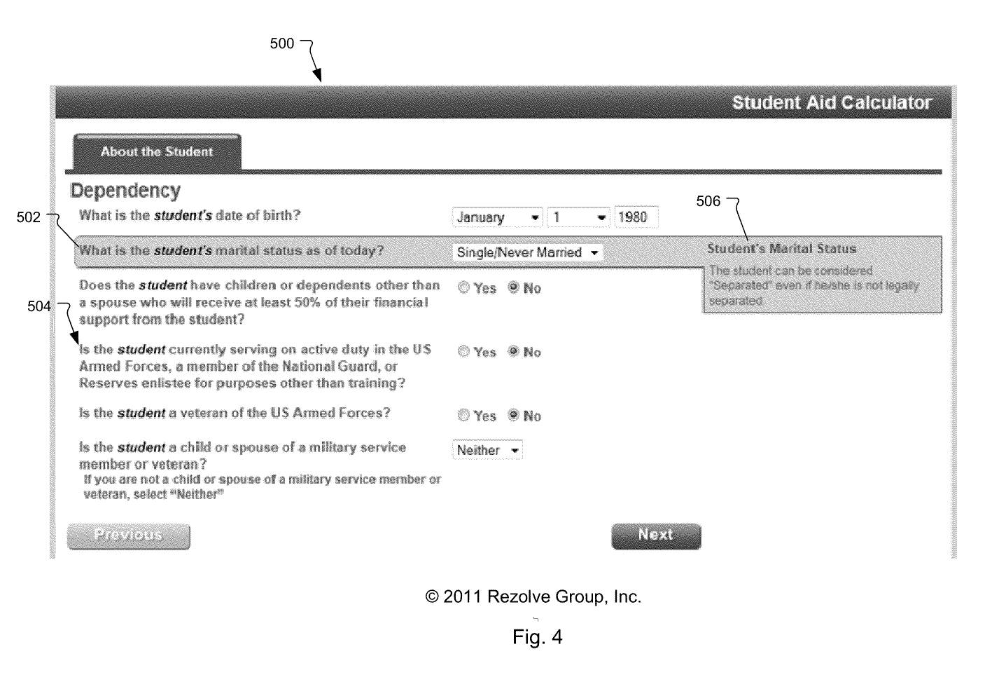

Generally, the first webpage after the registration page is an introduction page 1108 (see FIG. 3A). This page provides general information about the net price calculator and survey. The following page is the registration page where a potential student creates an account (See FIG. 3B). The survey pages 1110 are customizable by the academic institution to collect as much or a little information needed for the net price calculation and award packet. In a typical implementation, the survey collects personal, academic, and financial information about the potential student and their family (See FIGS. 4-8).

Additionally, the computer system also performs error checking to ensure that valid information has been entered into the computer system based on field level and survey level validations rules that are built in and maintained. For example, field level validation is performed such as checking that an email address is properly formed, or that letters have not been included when entering a telephone number.

If there are errors, then the computer system 106 presents an error screen and the candidate is required to fix the errors before viewing the summary pages 1112 or output pages 1114. Additionally, once the survey is complete and without errors, then the computer system 106 saves the information collected by survey to the transaction database 1106.

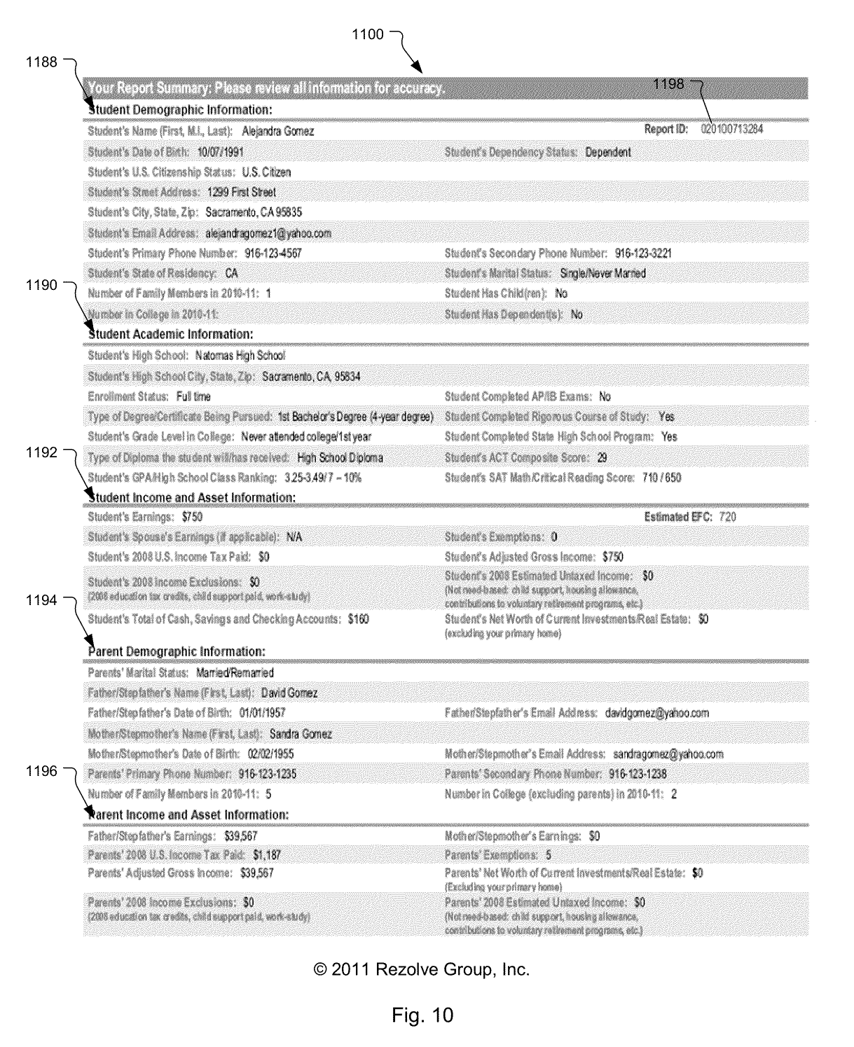

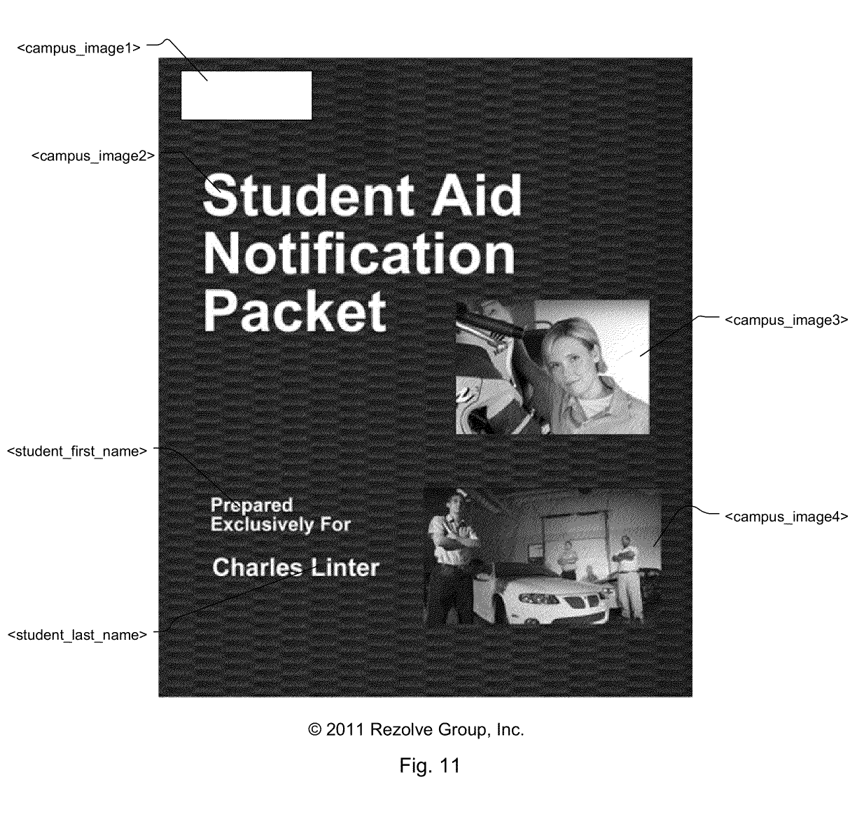

After saving the information to the transactional database, the entered data are displayed in the summary pages 1112. The summary page 1112 provides a detailed overview of the information collected via the NPC survey (See FIG. 10). It allows the potential student to view, edit, and check the accuracy the information entered by the student during the survey.

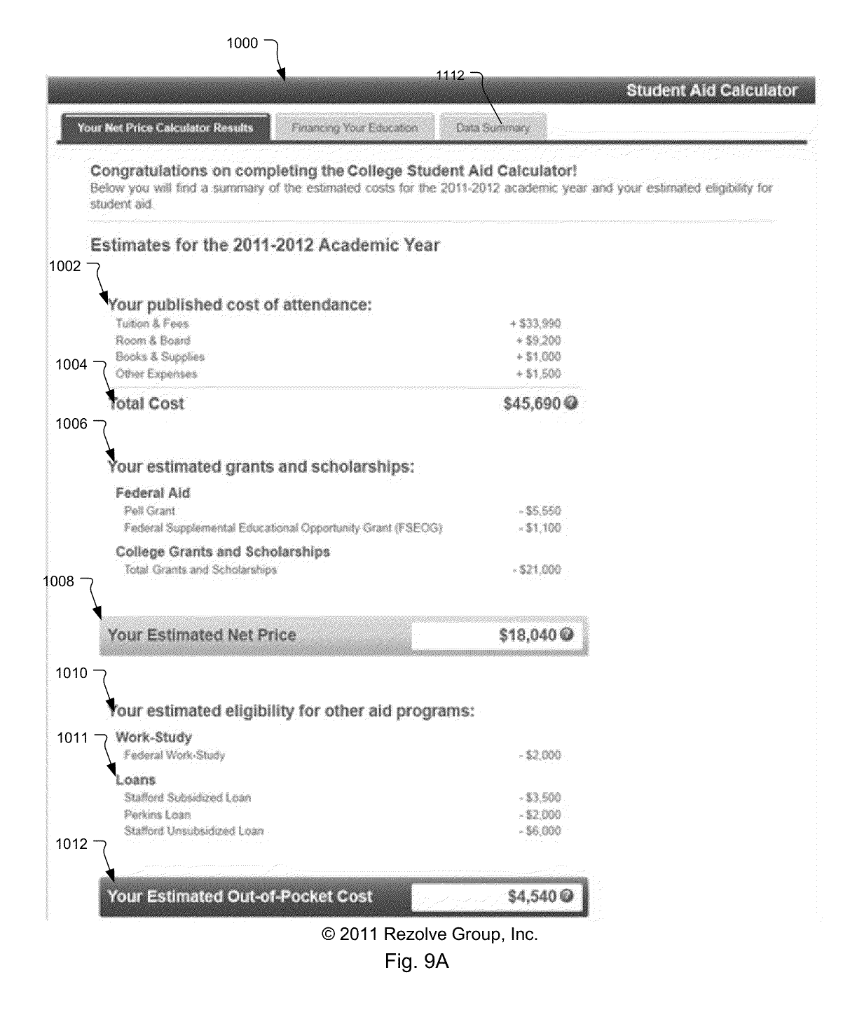

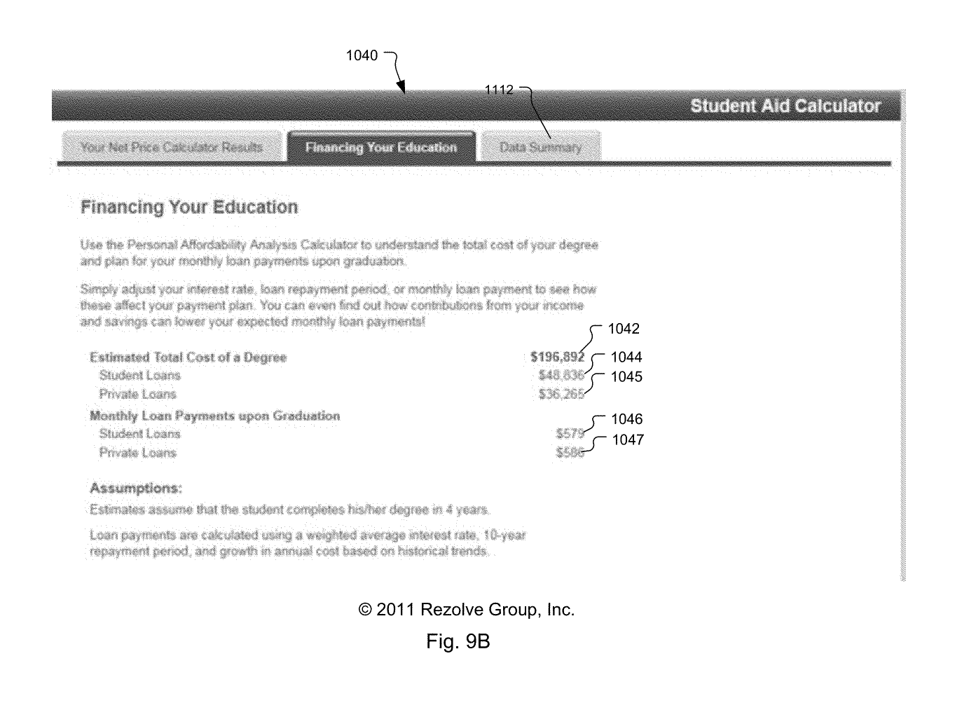

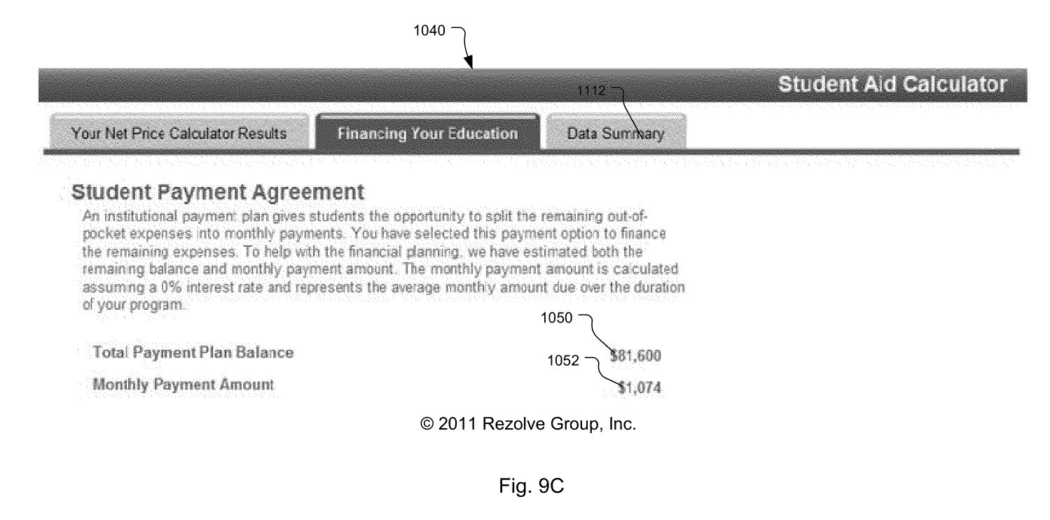

Additionally, in alternative embodiment, this NPC survey information can be acquired via a phone operator. In that scenario, the phone operator would view the questions displayed by the NPC 108, read the questions to the potential student over the telephone, and enter the responses supplied by the potential student. Additionally, the summary pages 1112 are accessible via the data summary tabs on the output pages 1114 (See FIGS. 9A-9C, reference numeral 1112).

The output pages 1114 display the results of the net price calculation as a series of screens that display different calculations related to the cost of attending the academic institution (see FIGS. 9A-9C). The information displayed in the output pages 1114 is generated by the student aid estimation engine 1122. The student aid estimation engine 1122 obtains the necessary financial and academic information from the business rules and transactional data 1104 collected during the survey pages 1110. The information is transferred to the output web service 1124, then to the output pages of the NPC 108

The output pages 1114 display important information such as tuition and fees, room and board, books and supplies, estimated financial aid, estimated net price and estimated out of pocket expenses to list a few examples. Based on the information gathered during the survey and the requisites defined by the academic institution, the award packet qualifier 1116 determines if the student qualifies for an award packet. Each academic institution is able to define the requirements that determine whether a potential student qualifies for an award packet. This is because is generally economically feasible to send the customized ward packet to every single potential student. If the student does not qualify for an award packet, then the student is directed to an end page 1118. From the end page 1118, the potential student is still able to access, view, edit, and use the NPC calculator to generate total cost calculations. The computer system 106, however, does not signal the award packet driver 1128 to generate an award packet for the potential student.

If the potential students do qualify for an award packet, then the potential student is directed to a confirmation page 1120 where the student is offered the award packet. Should the student choose to receive an award packet, the computer system will gather registration information from the student such as full name, mailing address and email address. This survey page will include a validation of the mailing address to verify the address is deliverable. These records will be flagged for award packet generation and included by the award packet driver when transferring information to the award packet output file 1132. The computer system 106 then signals the award packet driver 1128 to gather the necessary business rules content (i.e., custom photos, paragraph, templates based on the potential student's academic goals and interests) that will become part of the award packet sent to the potential student.

The award packet driver 1128 determines which content stored in the business rules database 1102 is included in the award packet for each potential student based on the registration information that was flagged after the potential student chose to receive an award packet on the confirmation page 1120 and based on information from the survey. The award packet driver 1128 also sends a command to the output web service 1124 to generate an award packet. The output web service 1124 compiles the potential student's calculated net price information from the student aid estimation engine 1122, as well as the financial and personal information stored in the transactional database 1106. The student aid estimation engine 1122 generates predicted financial aid awards, net costs, and loan repayments based on the information entered by the potential student during the NPC survey 1110 (see FIGS. 9A-9C).

The award packet driver 1128 then analyzes the potential student's transactional data to determine the potential student's academic goals and personal interests based on their responses to the questions in the survey. In response to the student's academic goals and personal interests, the award packet driver 1128 selects content (customized photos, paragraphs, templates, backgrounds, and additional information) from the data stored in business rules database 1102 that are relevant to the potential student's academic goals and interests. The information is then transferred to the award packet data file 1132.

After receiving the command to generate an award packet, the output web service 1124 compiles the potential student's transactional data. The transactional data includes the results of the calculated net price information from the student aid estimation engine 1122 and academic, financial, and personal information collected during the NPC survey. The output web service 1124 collects the potential student's personal, academic, and financial aid information from the business rules and transactional data and transfers the information to the output data file 1130.

The award packet data file 1132 and output data file 1130 are then merged by the document generator 1134. The document generator 1134 seamlessly combines the financial and personal information of the potential student from the output data file 1130 with relevant content from the award packet data file 1132. The result is a customized award packet that is specifically tailored to the interests of the potential student. Thus, the potential students receive individualized information that is relevant to their interest in the academic institution whether they are interested are engineering, poetry, music, or chemistry. Likewise, the academic institution is able to better recruit students because the information being sent to each student is personalized to the potential student's interests.

In a typical implementation, the document generator 1134 converts the award packet into portable document format (PDF) 1138. Once in PDF format, the award packet PDF 1138 is ready to be delivered to the potential student.

In one embodiment, the award packet PDF 1138 is converted to a letter shop file for printing and mailing via a letter or print shop and sent through the postal system. Typically, the academic institution sends hundreds or thousands of customized award packets PDF to the print shop. The letter shop 1144 is then able to print and mail the documents to the potential student 1146 on behalf of the academic institution. Generally, the letter shop is a third-party service provider such as a commercial print shop. Alternatively, the letter or print shop is part of a department within the academic institution.

In an alternative embodiment, the award document PDF 1138 is made available to the document downloader 1140 on a webpage hosted by academic institution or through NPC interface. In one embodiment, the document is made available on the confirmation page 1120 or on an additional page that is served to the potential student 1146 after they have confirmed their information on the confirmation page 1120. The document downloader 1140 enables the potential student to access their award packet immediately after it is generated.

In an alternative embodiment, an email is sent to the potential student's email address with a hyperlink (or link) that directs to potential student to the document downloader page. In yet an alternative embodiment, the award packet PDF 1138 is attached and sent via email 1142 to the potential student's email address that was provided by the student during the survey. The potential student selects this method of delivery via the confirmation page 1120 or through an option presented on an additional page that is served to the potential student 1146 after they have confirmed their information on the confirmation page 1120. The academic institution has the option to default the method of delivery for all students (such as only generating PDFs or providing both PDF and printed copies). Additionally, the potential student is also able to include additional email addresses that would also receive the award packet PDF.

FIG. 2B shows how data are stored as data files and managed by the business rules database 1102 and transactional database 1106.

Typically, the data files within the databases 1102, 1106 are managed by a database management system. A database management system is generally software that enables access, modification, and deletion of the contents of the database. Often the database management system enables different applications and/or services to access the database simultaneously.

In a preferred embodiment, the business rules database 1102 stores data files related to the academic institution such as the Organization.txt data file 1172, SchoolProfiles.txt data file 1174, Programs.txt data file 1176, SchoolProfileFacts.txt data file 1178, GeneralAidMessages.txt data file 1180, CampusProfiles.txt data file 1182, to list a few examples. These data files store output values (or document content tags) that are accessed by the award packet driver 1128 when generating an award packet for a potential student.

In a typical implementation, the award packet driver 1128 determines which content is to be included in the award packet and then accesses the business rules database 1102 and corresponding data file to gather the required content. The output values are then transferred to the award packet data file 1132.

The transactional database 1106 stores potential students' information as it is entered by the students during the NPC survey 1110. Unique data files (e.g. data files 1160-1170) are created for each potential student. The data files are indexed by a student identification number and application number to ensure that information is associated with the corresponding potential student.

Additionally, the transactional database 1106 stores other student data files for each potential student such as StudentSchoolProgramCost.txt 1168 and StudentAid.txt 1170. These data files include school cost information and student aid information for each student calculated by the NPC 108. As before, they also include the student identification number and application number to associate the data with the corresponding potential student.

In a typical implementation, the output web service 1124 gathers the flagged information that is included in the award packet from the transactional database 1106 and corresponding data files to gather the required content. The output values are then transferred to the output data file 1130.

FIG. 3A shows an exemplary welcome screen 200 displayed to potential students and provides introductory information about the net price calculator and survey. The welcome screen provides introductory information about the net price calculator, how long the survey takes 202, and a reminder 204 of documents that would be helpful to the student while completing the survey.

FIG. 3B shows an exemplary registration screen 400 that is optional. Potential students are not required to complete this section before beginning the survey, unless they want to have an award packet generated. In order to have an award packet generated, the academic institution needs the contact information of the potential student.

In a typical implementation, the potential students enter personal information into the computer system 106. The personal information includes name 402, and contact information 404 such as address, country, city, state, zip code, email address, and phone number 406. If the potential students had previously registered, then the potential student is not required to re-enter their personal and contact information.

FIG. 3C shows an exemplary personal interests screen 300. The personal interest screen collects information about the personal interests of the potential student.

Using a drop-down menu 302, the potential student is able to select from a predefined list of activities and programs such as art, dance, communications, theater, English and marketing to list a few examples. In alternative embodiments, many different interests may also be included such as sports clubs, movies, music, or student government. Additionally, a second drop-down menu 304 is included for specific program that have scholarship opportunities.

In one embodiment, the personal interests screen 300 includes a drop-down menu 306 for the number of community services hours the student has completed in addition to the hours mandated by the potential student's high school. In an alternative embodiment, the personal interests screen 300 includes an entry field to enter the name and/or location where the community service was performed.

The personal interests screen 300 includes a list 308 of leadership awards, activities, or organizations in which the student has participated. The list 308 includes an option to add other awards, activities, or organizations 310. If the potential adds their own organization of program, then a field 312 is created for the potential student to add their own organization or program. Additionally, the personal interests screen 300 creates another option to add other awards, activities, or organizations 314 to enable to potential student to add as many additional clubs or organizations.

FIG. 4 shows an exemplary personal information screen 500 that requires the potential student to enter information to determine dependency status as defined by the Department of Education such as the student's date of birth, if the student has dependents and if the student is/was serving in the U.S. military service. In a typical implementation, the potential student is required to list their marital status 502, as well as questions about their military service 504. Additionally, a help box 506 is displayed to provide additional guidance to the potential student while they complete the survey.

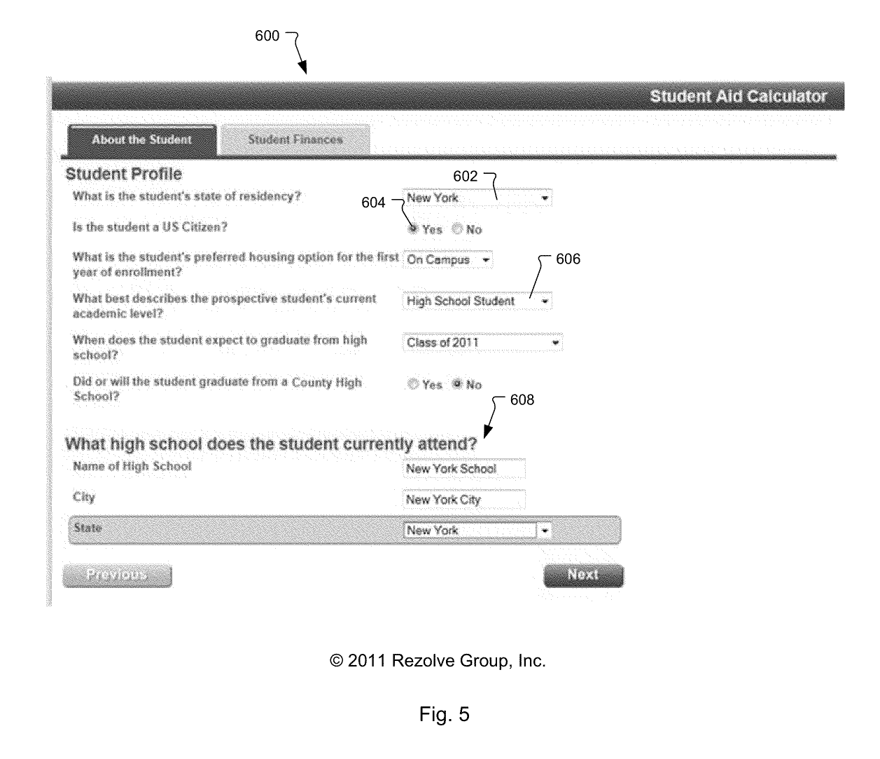

FIG. 5 shows an exemplary a personal information screen 600 that requires the potential student to enter additional personal information related to the potential student's citizenship, residency, and their high school. The questions displayed to the potential student vary based on the required eligibility criteria for applicable student aid programs at each institution.

The potential student is typically required to enter a state of residency 602 and whether they are a United States Citizen 604. Likewise, the potential student is required to enter the highest level of education achieved 606. If the student is still in high school, then the computer system 106 requests the potential student to provide the name of the school and the state where the high school is located 608.

Preferably, the potential student is required to select the desired campus and program of study. This is typical for academic institutions that are spread across multiple campuses and offer a range of program of studies based on campus. The combination of campus selection and program of study drives the total cost of attendance. The academic institution is able to determine eligibility for financial aid programs based on the campus and program of study selection.

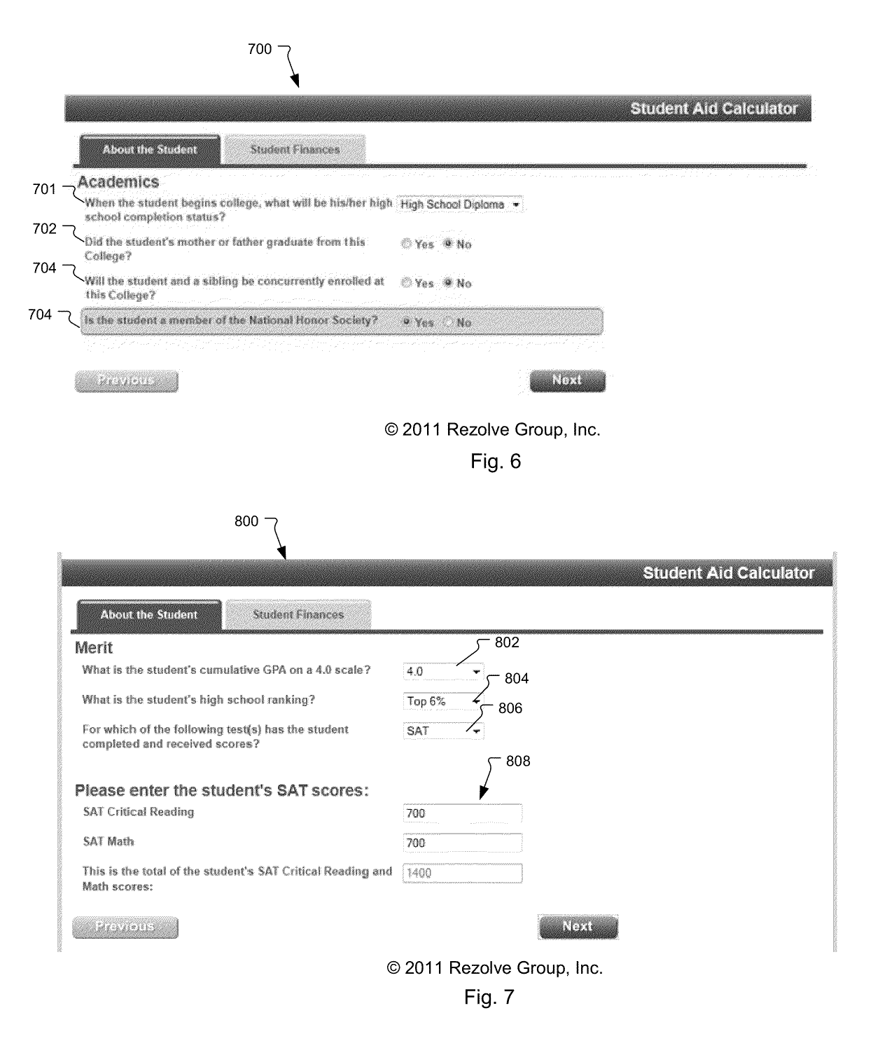

FIG. 6 shows an exemplary academic information screen 700 that requires the potential student to enter information about academics. In the example provided, the potential student is required to enter academic completion status 701, whether their mother or father graduated from this college 702, whether a sibling will be concurrently enrolled at this college 704, and whether the potential student is a member of the National Honor Society 704. The question set displayed on this page is typically customized by academic institution. Any additional academic requirements necessary to receive institution specific aid are included in this section. These factors help the academic institution determine eligibility for need- and merit-based financial aid programs and vary in each embodiment of the software and computer system developed for different institutions.

FIG. 7 shows an exemplary academic information screen 800 that requires the potential student to enter additional information about their academic performance to help the student aid estimation engine 1122 to calculate merit-based financial aid. The potential student is required to enter information about their grade point average (GPA) 802, the student's ranking in high school 804, and whether the student has taken the ACT and/or SAT tests 806 and their scores for the test 808. If there are additional merit requirements necessary to receive institution specific aid, the academic institution can choose to customize their question set and add it to this page or any page within the survey.

These compilations of information and scores enable the computer system 106 and student aid estimation engine 1122 to be able to determine if potential students meet the basic requirements to qualify for any merit-based grants, scholarships, or loans.

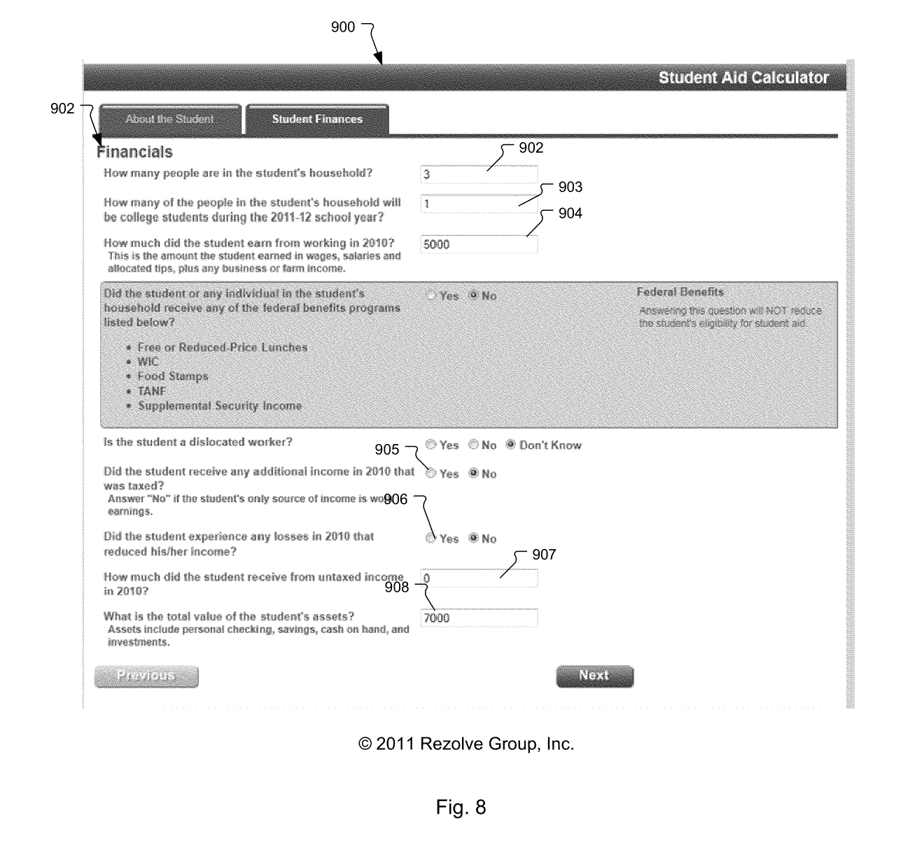

FIG. 8 shows an exemplary financial information screen 900 that requires the potential student to enter financial information. If the student is a dependent student by the definition promulgated by the Department of Education, then the questions listed would be directed towards the student's parent(s).

The potential student is required to enter how many people are in the same household as the potential student 902 and how many of people in the household will be attending college in the academic year 903.

The potential student is also required to enter how much money they made in income 904, as well as additional income 905 (for example, interest from bank accounts or investments), financial losses (for example, losses to investments), untaxed income 907, and the total value of the potential student's assets 908.

FIG. 9A shows an exemplary net price calculator results screen 1000 that provides a detailed overview of the estimated cost of attendance for specified academic institutions. The estimated cost of attendance can vary for potential students at the same academic institution. For example, it can vary for in-state/out-of-state residents, by program of study, and grade level. The results page is fully customizable and built in a modular fashion that allows the institution to control the content, design, and display of student aid eligibility and net price.

The computer system 106 displays the published cost of attendance 1002. The published cost of attendance 1002 includes tuition and fees, room and board, books and supplies, and other expenses. In an alternative embodiment, the computer system 106 is able to include a breakdown of what each expense includes as well as additional expenses students are likely to have, such as personal costs, transportation and/or parking costs, and insurance costs, to list a few examples. The result is the total cost 1004 for the academic year or total program of study. In examples, the total cost of attendance and eligibility for different sources of student aid are also graphically represented in the form of a pie char.

The student aid estimation engine 1122 calculates the potential student's expected family contribution (EFC). The academic institution uses the EFC to determine need (total cost minus EFC) and impacts the amount of need-based student aid the potential student may receive. There are two methods to calculate an EFC: the federal methodology as defined by the Department of Education and a modified methodology. Some academic institutions apply modifications to the federal method to award their college-specific awards. If the potential student plans to enroll in a program with academic years that are less than 9 months (commonly for non-term programs), the EFC is prorated. Once the EFC is calculated, the student aid estimation engine 1122 of the computer system 106 then calculates the potential student's estimated grants and scholarships 1006. The computer system 106 displays the federal (including military education benefits), state and institution-specific financial aid for which the potential student qualifies and will likely receive if they apply to the academic institution. The computer system 106 then displays the estimated net price 1008. The estimated net price 1008 is the total cost of attendance 1004 minus federal and state grants and scholarships 1006.

In some cases, the student aid estimation engine packages aid awards up to the direct cost of attendance. The direct cost of attendance generally includes tuition and fees and occasionally books and supplies. For institutions with on-campus housing options, it may also include room and board charges. The estimated grants, scholarships and net price are graphically represented in the form of a pie chart, in some examples.

The computer system 106 then calculates estimated eligibility for other financial aid programs 1010, which typically includes work-study, loans, military aid, and self-reported outside scholarships. Lastly, the computer system 106 then calculates the estimated out-of-pocket cost 1012. Out-of-pocket cost 1012 represent the amount of ‘day one’ or ‘up front’ money the student and/or family is expected to pay after all student aid sources have been funded. The out-of-pocket cost 1012 is the estimated net price 1008 minus the sum of work-study, loans and self-reported outside scholarships. In examples, the estimated eligibility for other financial aid and remaining out-of-pocket cost are graphically represented in the form of a pie chart.

FIG. 9B shows an exemplary financing your education screen 1040 that provides information on the total cost of obtaining a degree 1042, estimated loans accumulated 1044, 1045, and the estimated monthly loan payments upon graduation 1046, 1047. In an alternative embodiment, students will have the option to choose how they would like to fund their out of pocket expenses via a private loan, institutional payment plan, or parent (PLUS) loan (for dependent students only).

In a typical implementation, the computer system 106 determines the duration of the degree or program based on the program of study selected by the potential student. The net price calculator 108 factors in historical cost increases such as inflation, annual tuition increases, and annual room and board increases to calculate the compounded annual growth rate. In an alternative embodiment, the computer system 106 calculates and displays calculations for students that complete their degree in longer or shorter lengths of time, continuing students who have prior student loans, students who attend multiple academic institutions, and students who obtain multiple or joint degrees. Additionally, for transfer students the computer system 106 accounts for the transfer credits allowable to determine the remaining program duration for the potential student and calculate the total cost of degree.

Also, potential students who elect to attend part-time or less than full-time will have varying program lengths to complete a degree. The computer system 106 factors in the number of credits completed per academic year and duration of the program to determine the total cost of degree.

The total cost of the degree 1042 is calculated by summing the total cost of attendance for one year 1004 with the extrapolated future costs increases for each additional year. The cost increases are represented as a numerical percentage referred to as the compound annual growth rate which is configurable. The computer system 106 uses an annual growth rate based on historic trends of cost increases at the academic institution, determining an annual growth rate that represents those costs increases, and applying the annual growth rate to the cost of attendance 1004. The computer system 106 then repeats the calculation process for the additional years required to obtain the degree.

The financing your education screen 1040 displays the total amount of student loans 1044 the student is likely to accumulate in 4 years at the academic institution. The number of years that is displayed is based on the degree duration and expected time to complete a degree at each institution. This number is based on one-year loan amounts 1011 generated and displayed in the Net Price Calculator results screen 1000 and extrapolated over the term of the selected degree program. The amount of money a student needs to fund their education is directly related to the cost of attending the academic institution. For this reason, the computer system 106 performs a similar annual growth rate calculation to determine the additional amount of student loans 1044 a student needs to fund their education for the length of the degree program. Borrowing limits are applied to the Stafford Direct loans based on an annual basis, as determined by the lifetime aggregate Stafford loan borrowing limits. For example, at the time of this writing, a freshman dependent student can borrow up to $3,500 for the Stafford subsidized/Direct loan and an additional $2,000 for the Stafford unsubsidized loan. Sophomores can borrow up to $4,500 for the Stafford subsidized loan and an additional $2,000 for the Stafford unsubsidized loan. Junior and senior year Stafford unsubsidized awards are increased by $2,000. In determining the student's total loan amount, the borrowing limits are applied to prevent the over-awarding of student loans.

The financing your education screen 1040 also includes the total estimated amount of parent loans likely to be accumulated in the years the student attends the academic institution for dependent students. Parent loans, are loans typically borrowed by parents (not the students) to help fund their child's education. Parent loans are calculated for dependent students and Private loans are calculated for independent students. In an alternative embodiment, the prospective student will have the option to choose which funding option they would prefer for their out of pocket expenses. The results page adjusts dynamically based on the user's selection.

Typically, parent loans are commonly used to help fund their child's education because Perkins, Stafford unsubsidized, and Stafford subsidized loans all have yearly (and lifetime) maximums on the amount that can be borrowed. Moreover, the limits are often less than the amount needed to completely cover the cost of attendance. Thus, some students and their families require additional funding sources to fund the cost of education. Generally, parent loans 1045 are calculated by determining how much a student still needs after subtracting all the other funding sources such as grants, scholarships, Perkins and Stafford loans, and out of pocket expenses.

Similar to the methodology for determining the cost of attendance and student loan increases, to determine the total parent loans the compound annual growth rate is applied to the amount needed for the first year and then extrapolated for each additional year needed to complete the degree program at the academic institution.

The financing your education screen 1040 also displays the estimated monthly loan payments 1046, 1047 upon graduation. The estimated monthly loans 1046, 1047 are based on a weighted interest rate, a ten year term (the default repayment term), and growth in annual costs based on historic trends.

The weighted interest rate is determined by factoring the amount or principal of each loan and the interest rate of the loan to determine a blended interest that reflects the different sizes and interest rates of each loan. Each loan: Stafford unsubsidized, Stafford subsidized, Perkins, and parent (PLUS) loans, all have fixed interest rates that are locked in by the students at the time of borrowing the loan. For example, (at the time of writing this document) Perkins loans have a fixed interest rate of 5%, Stafford unsubsidized loans (both have a fixed interest rate of 6.8%, and parent loans have a fixed interest rate of 7.9%. Stafford subsidized loans vary based on the academic year they were disbursed. These interest rates are configurable and may adjust based on federal regulations. Should a student choose to fund their out of pocket expenses with institutional payment plans or alternative/private loans, those options will be displayed to the end user.

The computer system 106 calculates the weighted interest rate by determining the product of each loan amount multiplied by each loan's the interest rate. Next, the computer system 106 sums the total of the products and divides that amount by the sum of all the loan amounts. The computer system uses a weighted interest rate when calculating the repayment amounts 1046, 1047 to more accurately predict the monthly loan payments upon graduation.

The computer system 106 calculates the capitalized interest accrued over the life of the loans (for the student and parent). For example, the Stafford unsubsidized loan has an interest rate of 6.8% that starts to accrue after the first disbursement of loan funds. Payment on this loan is deferred until 6 months after the student graduates. Over this time period, the interest is capitalized and added to the principal loan amount to determine the total loan value to be repaid by the borrower.

The computer system 106 then determines a monthly payment upon graduation by compiling the total loan amounts 1044, 1045, the weighted interest rate (see: 1064, 1088, 1090 in FIG. 10C), and the loan term to an amortization algorithm to determine how much the monthly payments need to be to fully repay the loans by the end of the repayment period.

In an alternative embodiment, the computer system 106 displays the total cost to obtain the degree 1042, total loans accumulated 1044, 1045, and monthly loan payments 1046, 1047 as ranges. The academic institution may opt to have the computer system 106 always display ranges regardless of the type of survey completed so that students are presented with a range of best and worst case scenarios for the cost and funding of their education.

FIG. 9C shows an alternative embodiment of an exemplary financing your education screen 1040 for an institutional payment plan for a non-term school.

Some academic institutions offer degree or certificate programs for studies that do not follow the traditional academic year calendar. For example, the school may offer an 18-month program that is divided into three academic years of 30 weeks each, as opposed to a traditional degree program that takes 4 years to complete and is divided into 4 academic years of 9 months.

Determining financial aid estimates for these institutions entail breaking the program of study cost and duration into packaging cycles. The number of cycles to package is determined by the academic year definition provided by the institution. For these institutions, an academic year can be defined in units of weeks, months, courses, clock hours, and/or credits.

To account for scenarios where the academic year does not meet the traditional academic year calendar or the definition provided by the institution, the student aid estimation engine 1122 calculates a prorated award amount for some financial aid programs (such as the Pell Grant) in order to account for an abbreviated or extended academic year and to distribute awards to meet the potential student's cost of attendance as determined per academic year. This requires the calculation of prorated Estimated Family Contribution (EFC) to determine the financial need to award some financial aid programs (such as Direct Subsidized or Federal Supplemental Education Opportunity Grant).

For these non-term programs of study, the student aid estimation engine 1122 calculates a prorated award amount for some financial aid programs (such as the Pell Grant) in order to account for an abbreviated academic year and to distribute awards to meet the potential student's cost of attendance as determined per academic year.

Additionally, in some cases, the academic institution provides alternative funding of the net price in the form of institutional payment plans. For example, the total payment plan balance 1050 is equal to the program remaining balance for the potential student. To calculate the monthly payment amount 1052, the total payment plan balance 1050 is divided over a payment period defined by the academic institution. Generally, the payment period is the duration of degree/program plus an extended period post-graduation period. In this example, the repayment period is 76 months, which results in a monthly payment of $1,074.

Additionally, the academic institution is able also to apply an interest rate when calculating the monthly payment amount 1052 for institutional payments.

FIG. 10 shows an exemplary report summary 1100. The report summary 1100 is a detailed overview of all the information entered by the potential student as part of the NPC survey 1110. This summary allows the student to review and later edit any missing or incorrect information. Each report summary 1100 includes a report ID 1198 that uniquely identifies the report summary for each potential student.

The report summary 1100 is divided into different sections that correspond to the different survey pages. The first section is the student's demographic information 1188 and includes information such as name, address, and contact information (see FIGS. 3B and 4).

The next section is the student's academic information 1190. The student academic information includes the student's high school, grade point average, and class ranking, and SAT scores (see FIGS. 5 and 6 of the net price calculation survey).

The next sections are the student's income and asset information 1192, parent demographic information 1194, and parent income and asset information 1196. These sections include student and parent total earnings, savings, and asset information as well as the parent's demographic information such as marital status, contact information, and whether other children are also enrolled in school, to list a few examples.

FIGS. 11-14 show how the information from the award packet data file 1132 and output data file 1130 are merged by the document generator 1134 to create the award packet document 1138.

FIG. 11 shows an exemplary cover page of an award packet PDF 1138 and how the data are transferred from the business rules database 1102 and transactional database 1106 to the award packet PDF 1138 to create a personalized document for each student. Each output value corresponds to data entered by a potential student and stored in the transactional database or to custom photos, paragraphs, backgrounds, and templates stored in the business rules database 1102 by the academic institution.

Table I shows exemplary output values and display details of the information typically displayed on a cover of an award packet PDF 1138. In one embodiment, the output values are document content tags. Typically, information related to academic institution (i.e., data not entered by the potential student during the survey) is pulled together using tags for the text & images. The document content data file has content associated with a particular tag along with criteria for when it should be displayed. Thus, when the computer system is generating an award packet, it needs the documentcontent.txt file, for example, to pull in the appropriate content/branding for that student.

TABLE I

| Cover (Output Value) | Display Details |
|---|---|
| <student_first_name> | Find <student_first_name> in the |
| | StudentPersonal data file |
| <student_last_name> | Find <student_last_name> in the |
| | StudentPersonal data file |
| <campus_image1> | To find the <campus_image1>, |
| | use the <campus_code> from the |
| | StudentPersonal data file to map |
| | to the CampusProfiles data file. |
| | Locate <campus_image1>. |
| <campus_image2> | To find the <campus_image2>, |
| | use the <campus_code> from the |
| | StudentPersonal data file to map |
| | to the CampusProfiles data file. |
| | Locate <campus_image2>. |
| <campus_image3> | To find the <campus_image3>, |
| | use the <campus_code> from the |
| | StudentPersonal data file to map |
| | to the CampusProfiles data file. |
| | Locate <campus_image3>. |
| <campus_image4> | To find the <campus_image4>, |
| | use the <campus_code> from the |
| | StudentPersonal data file to map |
| | to the CampusProfiles data file. |
| | Locate <campus_image4>. |

The table shows variables and there source in the files stored in the transactional database 1106 and the business rules database 1102. The output values are a combination of information that entered by the potential student during the survey 1110 and the customized images determined by the award packet driver 1128 based on the potential student's interests. The display details briefly describe which database and program code is used to locate the required information to be included in the award packet. In the example illustrated by Table I, a student interest in a particular campus as stored in the campus code variable for that student in their StudentPersonal1 data file is used as a lookup into the CampusProfiles datafile so that a campus_image1 picture is inserted into the student's award package.

Generally, the background color and style and overall template will be the same for all the award packets to create some uniformity across all the award packets, but because of the customizable nature of the award packets it is possible to vary the design of each award packet. For example, the academic institution is able to select from different default award packet options. The different options vary in size (i.e., number of pages) and which components are will be included with the award packet. The components include cover page, introduction letter, one-page college profile, two-page college profile, how Student aid work diagram, award letter, one-page your next step page, two-page your next steps page, Federal aid programs, state aid programs, institutional programs, other sources of aid, glossary, and back cover to list a few examples. These options, however, only represent common default options; the award packets are further customizable to include additional pages or components.

The computer system 106 has four default options for the award packet. Based on the academic institution's preference, they can choose to design an award packet that is basic and only includes a few of the major components. Likewise, the academic institution can choose design an award packet that includes significantly more information or anything n between.

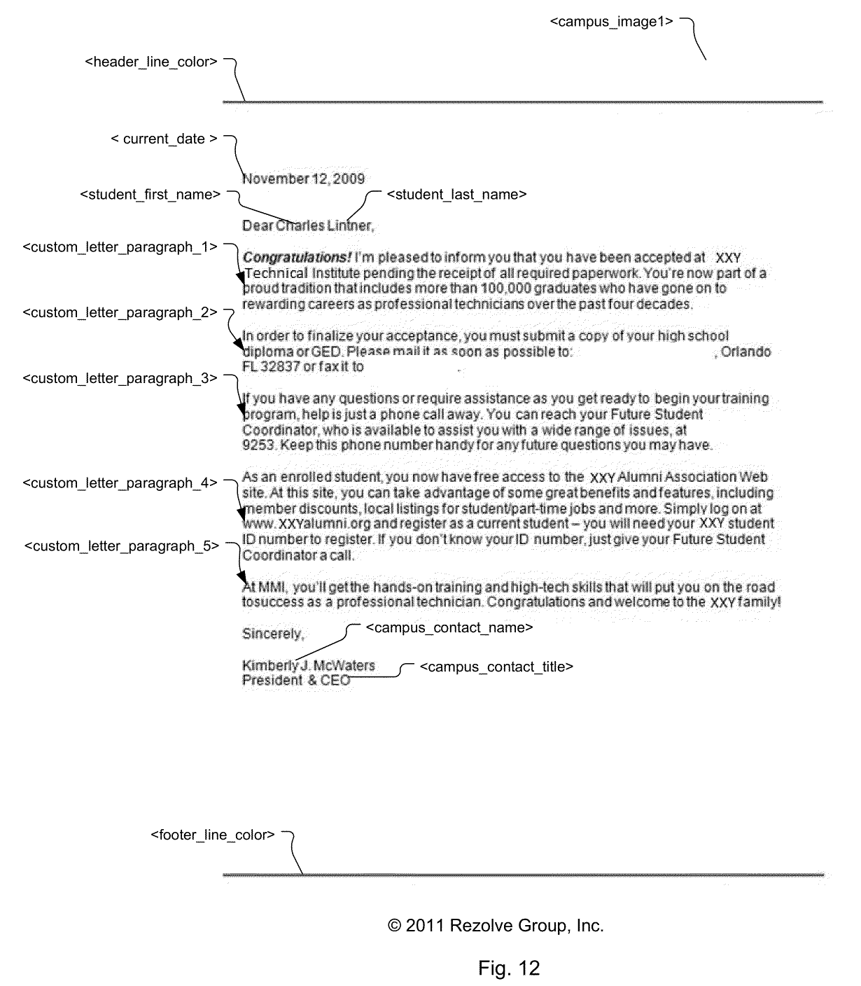

FIG. 12 shows an exemplary custom welcome letter an award packet PDF 1138 and how the data are transferred to the award packet PDF 1138 to create a personalized document for each student.

Table II show output values and display details of the information typically displayed in the custom welcome letter of an award packet PDF 1138.

TABLE II

| Custom Letter (Output Value) | Display Details |
|---|---|
| <header_line_color_C> | Find <header_line_color_C> in the |
| | organizations.txt file. |
| <header_line_color_M> | Find <header_line_color_M> in the |
| | organizations.txt file. |
| <header_line_color_Y> | Find <header_line_color_Y> in the |
| | organizations.txt file. |
| <header_line_color_K> | Find <header_line_color_K> in the |
| | organizations.txt file. |
| <custom_letter_paragraph_1> | Find <custom_letter_paragraph_1> |
| | in the organizations.txt file. |
| <custom_letter_paragraph_2> | Find <custom_letter_paragraph_2> |
| | in the organizations.txt file. |
| <custom_letter_paragraph_3> | Find <custom_letter_paragraph_3> |
| | in the organizations.txt file. |
| <custom_letter_paragraph_4> | Find <custom_letter_paragraph_4> |
| | in the organizations.txt file. |
| <custom_letter_paragraph_5> | Find <custom_letter_paragraph_5> |
| | in the organizations.txt file. |
| <campus_contact_name> | To find the <campus_contact_name>, |
| | use the <campus_code> from the |
| | StudentPersonal data file to map |
| | to the CampusProfiles data file. |
| | Locate <campus_contact_name>. |
| <campus_contact_title> | To find the <campus_contact_title>, |
| | use the <campus_code> from the |
| | StudentPersonal data file to map |
| | to the CampusProfiles data file. |
| | Locate <campus_contact_title>. |
| <footer_line_color_C> | Find <footer_line_color_C> in the |
| | organizations.txt file. |
| <footer_line_color_M> | Find <footer_line_color_M> in the |
| | organizations.txt file. |
| <footer_line_color_Y> | Find <footer_line_color_Y> in the |
| | organizations.txt file. |
| <footer_line_color_K> | Find <footer_line_color_K> in the |
| | organizations.txt file. |

The custom welcome letter shows how each document is able to be customized to the needs and interests of each potential student. For example, in addition to each potential student's name (<student first name>,<student last name>), custom paragraphs are included that relate to academic goals and interests of each potential student (<custom letter_paragraph_1> . . . <custom letter_paragraph 5>). In the exemplary welcome letter FIG. 12, the student has been accepted to the XXY Institute. The custom paragraphs include information about enrollment, a school contact to answer additional questions, information about access to the XXY alumni association's website, and a final congratulatory statement.

Moreover, the images on the cover page (see FIG. 11) are of mechanics and/or technicians working around vehicles. In a typical implementation, these types of images and custom paragraphs are only included in the award packet for potential students interested in automotive maintenance education. They would not be included for students who are interested in, for example, healthcare or computer programming.

The business rules database 1102 includes a wide selection of content for all the different possible interest a potential would have. The varied content allows the academic institution to create personalized award packets for each potential student.

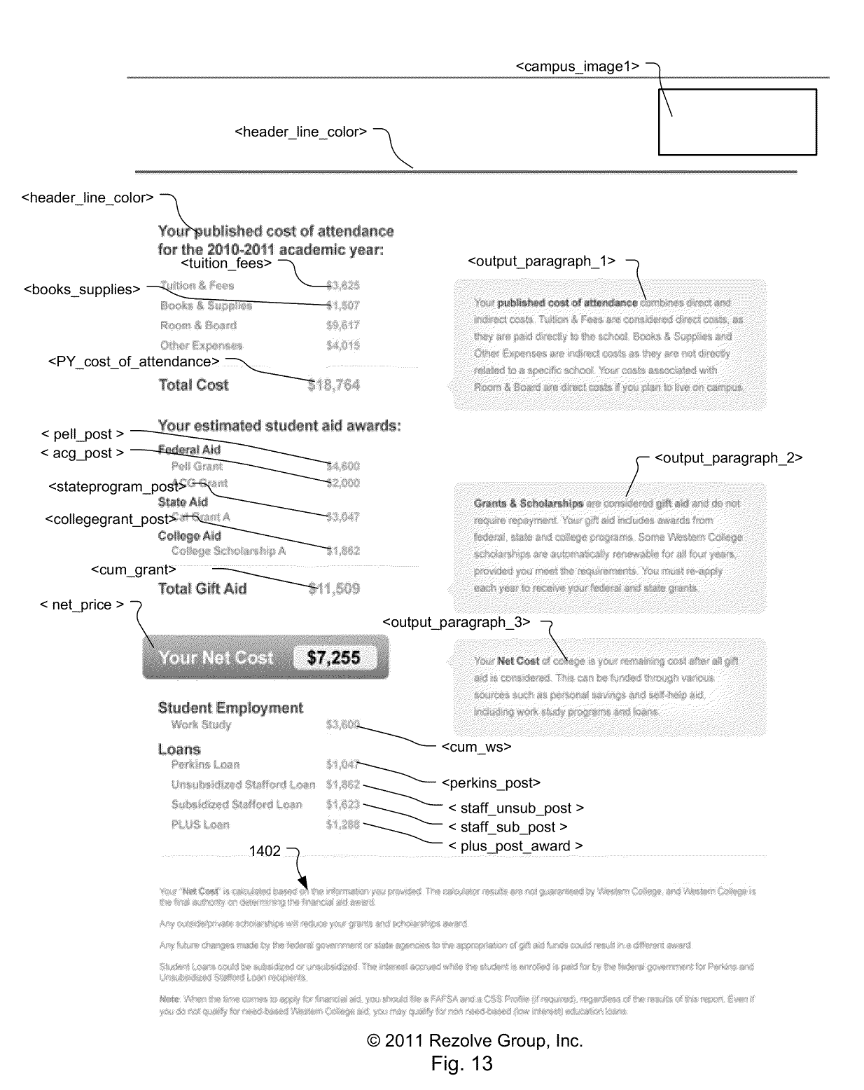

FIG. 13 shows an exemplary total price summary page and how the data are transferred to the award packet PDF 1138 to create a personalized award packet each potential student.

Table III shows output values and display details of the information typically displayed on the custom output page of an award packet PDF 1138.

TABLE III

| Output Page (Output Value) | Display Details |
|---|---|
| <header_line_color_C> | Find <header_line_color_C> in the organizations.txt file. |
| <header_line_color_M> | Find <header_line_color_M> in the organizations.txt file. |
| <header_line_color_Y> | Find <header_line_color_Y> in the organizations.txt file. |
| <header_line_color_K> | Find <header_line_color_K> in the organizations.txt file. |
| <campus_image1> | Logo = <campus_image1>. |
| | Use the <campus_code> in the StudentPersonal2 file |
| | to map to CampusProfiles file and locate the |
| | <campus_image1>. |
| <footer_line_color_C> | Find <footer_line_color_C> in the organizations.txt file. |
| <footer_line_color_M> | Find <footer_line_color_M> in the organizations.txt file. |
| <footer_line_color_Y> | Find <footer_line_color_Y> in the organizations.txt file. |
| <footer_line_color_K> | Find <footer_line_color_K> in the organizations.txt file. |
| <output_paragraph_1> | Customizable Output Paragraph 1 = |
| | <output_paragraph_1>. |
| | Find <output_paragraph_1> in the StudentSchools2 |
| | txt file. |
| | If <output_paragraph_1> = NULL or Blank, then DO |
| | NOT display grey box and roll-up. |
| <output_paragraph_2> | Customizable Output Paragraph 2 = |
| | <output_paragraph_2>. |
| | Find <output_paragraph_2> in the StudentSchools2 txt file. |
| | If <output_paragraph_2> = NULL or Blank, then DO |
| | NOT display grey box and roll-up. |
| <output_paragraph_3> | Customizable Output Paragraph 3 = |
| | <output_paragraph_3>. |
| | Find <output_paragraph_3> in the StudentSchools2 txt file. |
| | If <output_paragraph_3> = NULL or Blank, then DO |
| | NOT display grey box and roll-up. |
| <disclosure_1> | Disclosure 1 = <disclosure_1>. |
| | Find <disclosure_1> in the StudentSchools2 txt file. |
| | If <disclosure_1> = NULL or Blank, then roll-up. |
| <disclosure_2> | Disclosure 2 = <disclosure_2>. |
| | Find <disclosure_2> in the StudentSchools2 txt file. |
| | If <disclosure_2> = NULL or Blank, then roll-up. |
| <disclosure_3> | Disclosure 3 = <disclosure_3>. |
| | Find <disclosure_3> in the StudentSchools2 txt file. |
| | If <disclosure_3> = NULL or Blank, then roll-up. |
| <disclosure_4> | Disclosure 4 = <disclosure_4>. |
| | Find <disclosure_4> in the StudentSchools2 txt file. |
| | If <disclosure_4> = NULL or Blank, then roll-up. |
| <disclosure_5> | Disclosure 5 = <disclosure_5>. |
| | Find <disclosure_5> in the StudentSchools2 txt file. |
| | If <disclosure_5> = NULL or Blank, then roll-up. |
| <cost_of_attendance> | Cost of Attendance (COA) estimate = <py_cost_of_attendance>. |
| | Find <py_cost_of_attendance> in the StudentSchools txt file. |
| | This should be displayed as a dollar amount in the |
| | following format: “$XX,XXX”. |
| <tuition_fees> | Tuition and Fees Component of COA = <tuition_fees>. |
| | Find <tuition_fees> in the StudentSchools txt file. |
| | This should be displayed as a dollar amount in the |
| | following format: “$XX,XXX”. |
| | ***Please note that this field should never be passed |
| | NULL or blank.*** |
| <books_supplies> | Books and Supplies Component of COA = |
| | <books_supplies>.Find <books_supplies> in the |
| | StudentSchools txt file. This should be displayed as a |
| | dollar amount in the following format: “$XX,XXX”. |
| | ***Please note that this field should never be passed |
| | NULL or blank.*** |
| <program_name> | For the Federal Programs: PELL, ACG, Perkins, |
| | STAFF_SUB, STAFF_UNSUB, and PLUS |

PELL = Display <PROGRAM_NAME> with

<PROGRAM_CODE> matching Pell. (“Pell Grant”)

STAFF_SUB = Display <PROGRAM_NAME>

with <PROGRAM_CODE> matching STAFF_SUB.
(“Stafford Subsidized Loan”)

STAFF_UNSUB = Display <PROGRAM_NAME>

with <PROGRAM_CODE> matching STAFF_UNSUB.
(“Stafford Unsubsidized Loan”)

PLUS = Display <PROGRAM_NAME> with

<PROGRAM_CODE> matching PLUS. (“PLUS Loan”)
For State Program(s): Variable # of programs
depending on State

STATEPROGRAM_post = Display

<PROGRAM_NAME> with <PROGRAM_TYPE> = TOP

state_loan_program_post_award = Display

| | |
|---|---|
| | <PROGRAM_NAME> with <PROGRAM_TYPE> = TOP. |
| | **Find <PROGRAM_NAME>, <PROGRAM_CODE> and |
| | <PROGRAM_TYPE> in the Programs data file. |
| <pell_post> | PELL Grant award estimate = <pell_post>. |
| | Find the <min_award> with a <program_code> = |
| | PELL in the Student Aid data file. |
| | The award should be displayed as a dollar amount in |
| | the following format: “$XX,XXX” |
| | If <pell_post> = 0, then roll-up <program_name> and |
| | do not display. |
| <STATEPROGRAM_post> | State Program award estimate = <stateprogram_post>. |
| (only CA or PA campus will | Find the <min_award> with a <program_code> = |
| have this) | CA002 or CA006 if <state_residency> = 7 OR with a |
| | <program_code> = PA001 if <state_residency> = 41 |
| | For example, student is a resident of CA and is |
| | eligible for program_code CA002. Display award |
| | corresponding to <CA002_post> in dollar format: |
| | “$XX,XXX”. If <CA002_post> = 0, then roll-up |
| | <program_name> and DO NOT display. Additionally, |
| | if all state aid awards are 0, then also roll-up state |
| | award header text: “State Aid”. |
| | ** <min_award> and <program_code> can be found |
| | in the StudentAid data file. <state_residency> can be |
| | found in StudentPersonal data file. |
| <staff_unsub_post> | Stafford Unsubsidized Loan award estimate = |
| | <staff_unsub_post>. |
| | Find the <min_award> with a <program_code> = |
| | STAFF_UNSUB in the StudentAid data file. |
| | The award should be displayed as a dollar amount in |
| | the following format: “$XX,XXX”. |
| | If <staff_unsub_post> = 0, then roll-up |
| | <program_name> and DO NOT display. |
| <staff_sub_post> | Stafford Subsidized Loan award estimate = |
| | <staff_sub_post>. |
| | Find the <min_award> with a <program_code> = |
| | STAFF_SUB in the StudentAid data file. |
| | The award should be displayed as a dollar amount in |
| | the following format: “$XX,XXX”. |
| | If <pell_post> = 0, then roll-up <program_name> and |
| | do not display. |
| <plus_post_award> | PLUS Loan award estimate = <plus_post_award>. |
| | Find <plus_post_award> in the StudentSchoolCost data file. |
| | The award should be displayed as a dollar amount in |
| | the following format: “$XX,XXX”. |
| | If <plus_post_award> = 0, then roll-up |
| | <program_name> and DO NOT display. |
| <cum_grant> | Cumulative grant award estimate = <cum_grant>. |
| | Find this value by using the <all_grants_low> value |
| | from the StudentSchoolCost data file. |
| | The award should be displayed as a dollar amount in |
| | the following format: “$XX,XXX”. |
| | *Please note that this is treated differently than the |
| | post award amounts. Display <cum_grant> even if |
| | award is 0. |
| <perkins_post> | Perkins loan award estimate = <perkins_post>. |
| | Find <perkins_post> in the StudentSchoolCost data file. |
| | The award should be displayed as a dollar amount in |
| | the following format: “$XX,XXX”. |
| <net_price> | Remaining Cost estimate = <net_price> |
| | Find <net_price> in the StudentSchoolCost data file. |
| | This should be displayed as a dollar amount in the |
| | following format: “$XX,XXX”. |

In a typical implementation, the values displayed on the total price summary page of the award packet are nearly identical to the net price calculator results screen 1000. This is because all of the financial aid calculations made by the student aid estimation engine 1112 are saved to the transactional database 1106 along with the potential student's personal and academic information. When an award packet is created for a potential student their own previously entered information, which is stored in the transactional database 1106, is used to populate the award packet. This ensures the student is presented with accurate information about the cost of attending the academic institution, their estimated amount of financial aid, and their total out of pocket cost because the award packet utilizes calculations based on the information entered by the student during the survey 1110.

The total price summary page illustrates how transactional data entered by the potential student during the survey 1110 along with the predicted financial aid awards calculated by the student aid estimation engine 1120 are combined into the output data file 1130 and merged with the award packet data file 1132 by the document generator 1134. Each output value is able to be removed depending on the information the academic institution wishes to include with the award packet. For example, if a school does not offer school aid (<collegegrant post>), then the computer system is able to remove that output value from the total price summary page. The school is able to include as many or a few output values to each page as needed.

In the exemplary total price summary page, the award packet includes information about the cost of school, estimated student aid awards, a net cost, and additional loans and grants the student qualifies for, and the dollar amount the student will likely receive.

Additionally, the school is able to include informational paragraph (<output_paragraph_1> . . . <output_paragraph_3>) and legal disclaimers 1402 to the award packet as well. All of these output values, informational paragraphs, headers, footers, logos, and disclaimers are part of the customizable content stored by the business rules database 1102 and transactional database 1106 that is able to be included/remove from the award packets.

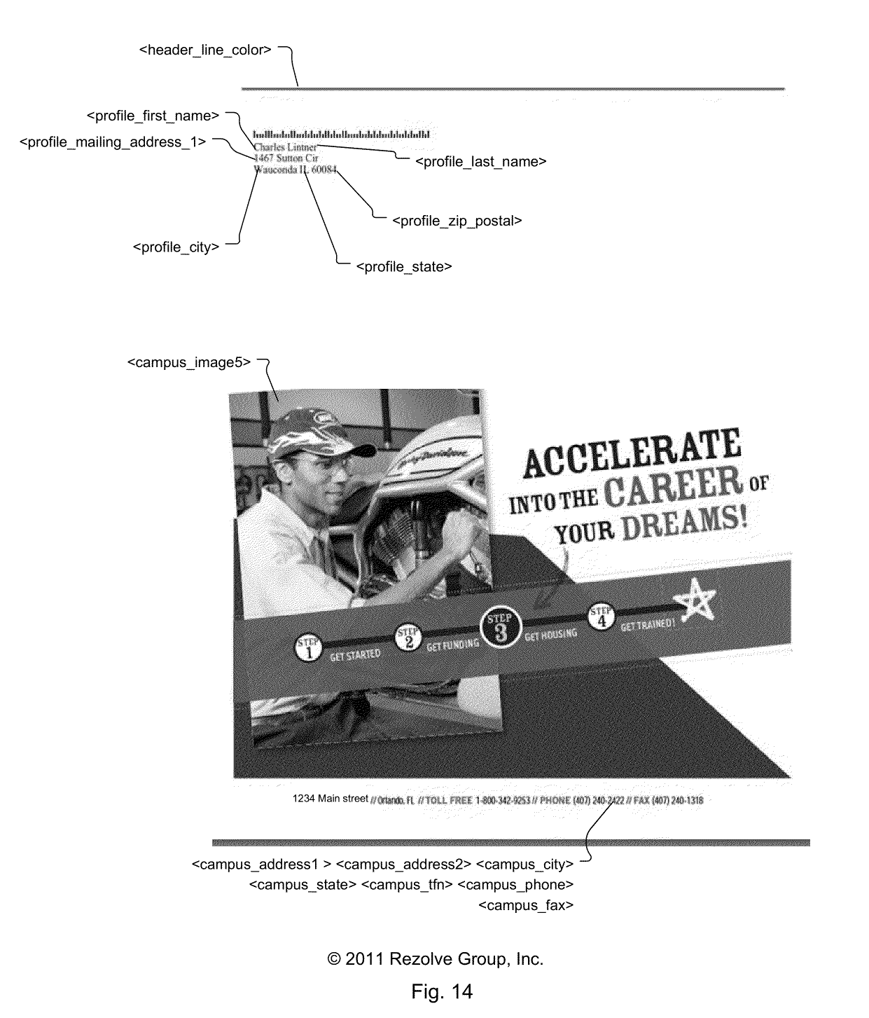

FIG. 14 shows an exemplary back cover page and how the data are transferred to the award packet PDF 1138 to create a personalized document for each potential student.

Table IV shows output values and display details of the information typically displayed in the custom back cover of an award packet PDF 1138.

TABLE IV

| Back Cover (Output Value) | Display Details |
|---|---|
| <profile_first_name> | Find <profile_first_name> in the |
| | StudentPersonal data file. |
| <profile_last_name> | Find <profile_last_name> in the |
| | StudentPersonal data file. |
| <profile_city> | Find <profile_city> in the |
| | StudentPersonal data file. |
| <profile_mailing_address_1> | Find <profile_mailing_address_1> |
| | in the StudentPersonal data file. |
| <profile_state> | Find <profile_state> in the |
| | StudentPersonal data file. |
| <profile_zip_postal> | Find <profile_zip_postal> in the |
| | StudentPersonal data file. |
| <header_line_color_C> | Find <header_line_color_C> in the |
| | organizations.txt file. |
| <header_line_color_M> | Find <header_line_color_M> in the |
| | organizations.txt file. |
| <header_line_color_Y> | Find <header_line_color_Y> in the |
| | organizations.txt file. |
| <header_line_color_K> | Find <header_line_color_K> in the |
| | organizations.txt file. |
| <campus_image5> | Use the <campus_code> in the |
| | StudentPersonal2 file to map |
| | to CampusProfiles file and locate |
| | the <campus_image5>. |
| <campus_address1> | To find the <campus_address1>, |
| | use the <campus_code> from the |
| | StudentPersonal data file to map |
| | to the CampusProfiles data file. |
| | Locate <campus_address1>. |
| <campus_address2> | To find the <campus_address2>, |
| | use the <campus_code> from the |
| | StudentPersonal data file to map |
| | to the CampusProfiles data file. |
| | Locate <campus_address2>. |
| <campus_city> | To find the <campus_city>, |
| | use the <campus_code> from the |
| | StudentPersonal data file to map |
| | to the CampusProfiles data file. |
| | Locate <campus_city>. |
| <campus_state> | To find the <campus_state>, |
| | use the <campus_code> from the |
| | StudentPersonal data file to map |
| | to the CampusProfiles data file. |
| | Locate <campus_state>. |
| <campus_tfn> | To find the <campus_tfn>, |
| | use the <campus_code> from the |
| | StudentPersonal data file to map |
| | to the CampusProfiles data file. |
| | Locate <campus_tfn>. |
| <campus_phone> | To find the <campus_phone>, |
| | use the <campus_code> from the |
| | StudentPersonal data file to map |
| | to the CampusProfiles data file. |
| | Locate <campus_phone>. |
| <campus_fax> | To find the <campus_fax>, |
| | use the <campus_code> from the |
| | StudentPersonal data file to map |
| | to the CampusProfiles data file. |
| | Locate <campus_fax>. |

The back cover includes many of the same features described above. Additionally, because the award packet is mailed through the postal service to potential students, the back cover typically also includes the potential student's mailing address, return address, and location for postage in accordance with the rules and regulation of the postal service.

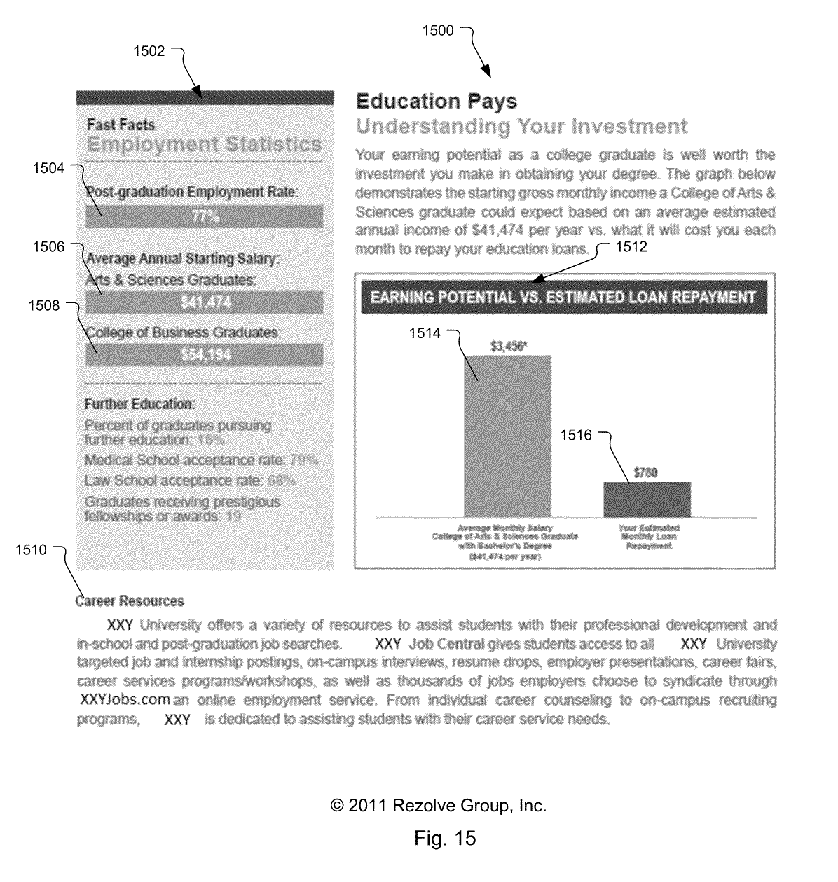

FIG. 15 shows the education pays screen (or page) 1500 that is typically included with an award package sent to a potential student. The education screen provides a brief summary about the value of an education at the academic institution and estimations of average starting salaries and loan payments after graduation. The education pays screen 1500 includes an employment statistics section 1502. The employment statistics are generated by the academic institution's career placement service and includes some general statistics about employment post graduation from the academic institution. The employment statistics section 1502 includes a post-graduation employment rate 1504, an average starting salary for Arts and Sciences 1506, and an average starting salary for college of business graduates 1508.

The education pays screen 1500 also includes an earning potential vs. estimated loan repayment section 1512. The earning potential vs. estimated loan repayment section 1512 section compares a typical monthly starting salary 1514 based on the potential student probable course of study and estimated earning potential after graduation 1514 and compares that amount to the estimated monthly payments loan repayments 1516 after graduation. The estimated earning potential after graduation 1514 is based on surveys conducted by the academic institution about previous year graduates who received bachelor's degrees from the academic institution. The estimated monthly payments loan repayment 1516 is a summation of total student loans 1046 and private loans 1047 (see FIG. 9B) calculated by the NPC 108.

Lastly, the education pays screen 1500 includes information about career placement resources 1510 available to potential at the academic institution.

While this invention has been particularly shown and described with references to preferred embodiments thereof, it will be understood by those skilled in the art that various changes in form and details may be made therein without departing from the scope of the invention encompassed by the appended claims.

What is claimed is:

1. A computerized method for generating a personalized document for marketing an academic institution to a potential student, the method comprising:
generating a user interface that enables entry of candidate personal information including candidate financial information into a computer system for the potential student;
the computer system determining expected financial aid award information for the potential student from the candidate financial information;
the computer system determining personalized marketing content that is relevant to the potential student based on the candidate personal information; and
the computer system generating a document customized to the potential student that includes the expected financial award information and personalized marketing content.

2. The method according to claim 1, wherein the document is transferred to a letter shop to be printed.

3. The method according to claim 2, wherein the letter shop prints and mails the document to the potential student.

4. The method according to claim 1, wherein the document is presented to the potential student via a document downloader.

5. The method according to claim 1, wherein the document is emailed to the email address of the potential student.

6. The method according to claim 1, wherein the computer system only creates a personalized document if the student qualifies for an award packet.

7. The method according to claim 1, wherein candidate financial information includes earned incomes, investment income, assets, savings, and debts and liabilities.

8. The method according to claim 1, further comprising generating the document customized to the potential student by combining candidate financial information and candidate personal information stored in a first database and personalized marketing content that is relevant to the potential student that is stored in a second database into a single document.

9. The method according to claim 8, wherein the candidate financial information and candidate personal information is stored in multiple data files within the first database.

10. The method according to claim 8, wherein the personalized marketing content is stored in multiple data files within the second database.

11. The method according to claim 1, wherein the computer system determines a cost of attendance for potential students and includes the expected financial aid award information and the candidate financial information to determine a net price of the academic institution for each individual student.

12. A computer system for generating a personalized document for marketing an academic institution to a potential student, the computer system generating a user interface that enables entry of candidate personal information including candidate financial information into a computer system for the potential student, determining expected financial aid award information for the potential student from the candidate financial information; determining personalized marketing content that is relevant to the potential student based on the candidate personal information; and generating a document customized to the potential student that includes the expected financial award information and personalized marketing content.

13. The system according to claim 12, wherein the document is transferred to a letter shop to be printed.

14. The system according to claim 13, wherein the letter shop prints and mails the document to the potential student.

15. The system according to claim 12, wherein the document is presented to the potential student via a document downloader.

16. The system according to claim 12, wherein the document is emailed to the email address of the potential student.

17. The system according to claim 12, wherein the computer system only creates and personalized document if the student qualifies for an award packet.

18. The system according to claim 12, wherein candidate financial information includes earned incomes, investment income, assets, savings, and debts and liabilities.

19. The system according to claim 12, further comprising generating the document customized to the potential student by combining candidate financial information and candidate personal information stored in a first database and personalized marketing content that is relevant to the potential student that is stored in a second database into a single document.

20. The system according to claim 19, wherein the candidate financial information and candidate personal information is stored in multiple data files within the first database.

21. The system according to claim 19, wherein the personalized marketing content is stored in multiple data files within the second database.

22. The system according to claim 12, wherein the computer system determines a cost of attendance for potential students and includes the expected financial aid award information and the candidate financial information to determine a net price of the academic institution for each individual student.
